(19) United States
(12) Patent Application Publication
(10) Pub. No.: US 2022/0151354 A1
(43) Pub. Date: May 19, 2022

(54) ELECTRONIC DEVICE CASES WITH TRACKS FOR HOLDING ACCESSORIES AND RELATED METHODS

(71) Applicants: Kristopher Jon Soderstrom, Raleigh, NC (US); Siegfried Lauren, Chapel Hill, NC (US)

(72) Inventors: Kristopher Jon Soderstrom, Raleigh, NC (US); Siegfried Lauren, Chapel Hill, NC (US)

(21) Appl. No.: 17/578,762

(22) Filed: Jan. 19, 2022

Related U.S. Application Data
(63) Continuation-in-part of application No. 16/897,621, filed on Jun. 10, 2020, now abandoned.
(60) Provisional application No. 62/966,392, filed on Jan. 27, 2020.
(60) Provisional application No. 62/966,380, filed on Jan. 27, 2020.

(51) Int. Cl. A45C 11/00; G06F 1/16; A45C 13/02; H04M 1/72409

(52) U.S. Cl. CPC A45C 11/00; G06F 1/1628; A45C 13/02; A45C 2013/025; A45C 2011/002; A45C 2011/003; A45C 2011/001; H04M 1/724092

(57) ABSTRACT

Electronic device cases with tracks for holding accessories and related methods are disclosed. According to an aspect, an electronic device case includes a body that defines an interior space for holding an electronic device. The case also includes a track attached to a side of the body and comprising first and second rails. The rails each define a protrusion that extends substantially along a length of the track. The protrusion of the first rail and the protrusion of the second rail extend in substantially opposing directions. The case also includes a locking mechanism comprising a resilient member that engages the first and second rails for biasing the first and second rails in a first position for holding an accessory. The resilient member resists movement of the first and second rails to a second position for release or receipt of the accessory.

### CROSS REFERENCE TO RELATED APPLICATIONS

This continuation-in-part (CIP) patent application claims priority to U.S. Nonprovisional patent application Ser. No. 16/897,621, filed Jun. 10, 2020, and titled DEVICE CASE COMPRISING A TRACK SYSTEM AND METHOD OF MAKING AND USING THE SAME, which claims priority to U.S. Provisional Patent Application Nos. 62/966,392 and 62/966,380, both filed Jan. 27, 2020, the contents of which are incorporated herein by reference in their entireties.

### TECHNICAL FIELD

The presently disclosed subject matter relates generally to electronic device cases. Particularly, the presently disclosed subject matter relates to electronic device cases with tracks for holding accessories and related methods.

### BACKGROUND

Portable electronic devices (such as cell phones) have become a primary communication device for a large portion of the public. Cell phone cases are used by most consumers that have cell phones to provide a degree of protection in the event of an impact, such as dropping the phone. Moreover, the case can protect the screen or camera lens by providing a ledge that can keep the surface raised. In addition to their phones, it is common for people to carry additional items and/or accessories when they leave their home, such as wallets, keys, writing utensils, and the like. As the number of accessories that a person carries increases, the more difficult it becomes to safely and securely carry each item. Currently, most users carry their cell phone and accessories in separate pockets or within separate compartments of a bag, purse, or briefcase. When a user desires to access a phone and/or accessory, he or she must rummage around to find the desired item. This can be time consuming and inconvenient. Furthermore, when a user carries multiple accessories, there is an increased likelihood that one or more items can be misplaced or dropped. It would therefore be beneficial to provide an electronic device case that allows for the convenient and customizable attachment and detachment of one or more accessories.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1a is a rear plan view of a device case in use in accordance with some embodiments of the presently disclosed subject matter.

FIG. 1b is a side plan view of the case of Fig. la.

FIG. 2a is a perspective view of a device case in accordance with some embodiments of the presently disclosed subject matter.

FIG. 2b is a front plan view of a device case in accordance with some embodiments of the presently disclosed subject matter.

FIG. 2c is a rear plan view of a device case in accordance with some embodiments of the presently disclosed subject matter.

FIGS. 3a and 3b are top plan views of track designs in accordance with some embodiments of the presently disclosed subject matter.

FIGS. 4a and 4b are rear plan views of device cases comprising tracks in various configurations in accordance with some embodiments of the presently disclosed subject matter.

FIG. 4c is a fragmentary view of a case comprising tracks in an angled configuration in accordance with some embodiments of the presently disclosed subject matter.

FIG. 5a is a side plan view of a case comprising sidewall tracks in accordance with some embodiments of the presently disclosed subject matter.

FIG. 5b is a side plan view of an accessory comprising an accessory track for the attachment of one or more accessories thereto.

FIG. 6a is a top plan view of a track system in accordance with some embodiments of the presently disclosed subject matter.

FIG. 6b is a cross-sectional view of a track system in accordance with some embodiments of the presently disclosed subject matter.

FIGS. 7a-7j are cross-sectional views of track systems in accordance with some embodiments of the presently disclosed subject matter.

FIG. 8 is a rear plan view of a device case in use in accordance with some embodiments of the presently disclosed subject matter.

FIGS. 9a-d are fragmentary views of device tracks comprising one or more electrical connections.

FIGS. 10a and 10b are fragmentary views of case tracks in accordance with some embodiments of the presently disclosed subject matter.

FIG. 11a is a fragmentary view of an accessory comprising a protrusion in accordance with some embodiments of the presently disclosed subject matter.

FIG. 11b is a cross-sectional view of an accessory comprising two protrusions in accordance with some embodiments of the presently disclosed subject matter.

FIG. 12a is a front plan view of a device configured with a case in accordance with some embodiments of the presently disclosed subject matter.

FIG. 12b is a rear plan view of a device configured with a case in accordance with some embodiments of the presently disclosed subject matter.

FIG. 12c is a side plan view of an accessory comprising a protrusion in accordance with some embodiments of the presently disclosed subject matter.

FIGS. 12d and 12e illustrate insertion of the accessory protrusion in the case track groove in accordance with some embodiments of the presently disclosed subject matter.

FIGS. 13a and 13b are rear plan views illustrating a case with one or more attached accessories in accordance with some embodiments of the presently disclosed subject matter.

FIGS. 14a and 14b are side plan views illustrating a track and/or rail locking system in accordance with some embodiments of the presently disclosed subject matter.

FIG. 15a illustrates a rear view of an electronic device case having a track for holding accessories in accordance with embodiments of the present disclosure.

FIG. 15b illustrates another rear view of the electronic device case shown in FIG. 15a without accessories being attached.

FIG. 15c illustrates a front view of the electronic device case shown in FIGS. 15a and 15b.

FIG. 15d illustrates a rear view of the electronic device case with an additional accessory being attached thereto via the rails.

FIG. 15e illustrates a side view of the electronic device case shown in FIG. 15d.

FIG. 15f illustrates a bottom view of the electronic device case shown in FIGS. 15d and 15e.

FIG. 16 illustrates a rear view of an electronic device case that is similar to the electronic device case shown in FIGS. 15a-15c.

FIG. 17 illustrates a bottom view of the electronic device case shown in FIG. 16.

FIG. 18 illustrates a bottom view of another example electronic device case.

FIGS. 19a and 19b and FIGS. 19c-19f illustrate rear views and close-up views, respectively, of another electronic device case that demonstratestwo (2) different locking mechanisms for holding an accessory in a desired position along a length of the case in accordance with embodiments of the present disclosure.

FIGS. 20a-20c are bottom views showing a sequence of using dual locking mechanisms of an accessory to engage and lock onto rails of an electronic device case in accordance with embodiments of the present disclosure.

FIGS. 21a-21c are bottom views showing a sequence of using dual locking mechanisms of an accessory to engage and lock onto rails of an electronic device case in accordance with embodiments of the present disclosure.

FIG. 22 illustrates a bottom view showing another example accessory with dual locking mechanisms similar to the accessory shown in FIGS. 21a-21c.

FIGS. 23a and 23b are a cross-sectional bottom view and a bottom view, respectively, of an accessory with a cam locking mechanism for locking to an electronic device case in accordance with embodiments of the present disclosure.

FIGS. 24a and 24b are a top views of an accessory with a locking mechanism with a lever for locking to an electronic device case in accordance with embodiments of the present disclosure.

FIGS. 25a and 25b are a top view and a cross-sectional top view, respectively, of an accessory with dual-rotating locking mechanisms for locking to an electronic device case in accordance with embodiments of the present disclosure.

FIGS. 26a and 26b are a top views of an electronic device case having a rail with a cam slide mechanism for locking an accessory into place in accordance with embodiments of the present disclosure.

FIGS. 27a-27c are a bottom view, a top view, and a side view, respectively, of accessories operatively connected together via their electrical interfaces in accordance with embodiments of the present disclosure.

FIGS. 28a and 28b are a top view and a side view, respectively, showing the accessories of FIGS. 27a-27c being connected directly to an electronic device within case.

FIGS. 29a and 29b are a side view and a top view, respectively, showing operable connection of a speaker to an electronic device (not shown) within an electronic device case via cable in accordance with embodiments of the present disclosure.

FIG. 30 illustrates a block diagram depicting an electronic device and an accessory that are operably connected in accordance with embodiments of the present disclosure.

FIG. 31 illustrates a flow diagram depicting an example method of interaction between an electronic device and a connected accessory in accordance with embodiments of the present disclosure.

### SUMMARY

The presently disclosed subject matter relates to electronic device cases with tracks for holding accessories and related methods. According to an aspect, the presently disclosed subject matter is directed to a device case. Particularly, the case comprises a body comprising an outer perimeter, and a sidewall attached to and extending about the outer perimeter of the body to define a recess, an inner case wall, and an outer case wall. The case further includes at least one track attached to the outer case wall, wherein the track comprises a pair of parallel ridges on either side of a groove. Each pair of ridges comprises at least one recess. The groove is sized and shaped to releasably receive a protrusion positioned on an accessory, such that the accessory is locked into a desired position on the track, and the accessory is releasably received within the groove at any desired location on the at least one track.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the case comprises at least one electrical contact area along the at least a portion of the length of the track.

In some embodiments, the at least one electrical contact area can send or receive data through direct connection with the device.

In some embodiments, the tracks are permanently attached to the outer case wall.

In some embodiments, the electrical contact area includes at least one contact track manufactured on a printed circuit board, microprocessor, or both.

In some embodiments, the case comprises two or more tracks arranged parallel, perpendicularly, or angled relative to at least one other track.

In some embodiments, the groove has a T, triangular, trapezoidal, round, squared, diamond, pentagonal, hexagonal, cross, or abstract cross-sectional shape.

In some embodiments, the groove is configured to allow the protrusion to be inserted in a horizontal or vertical orientation.

In some embodiments, the presently disclosed subject matter is directed to a system comprising a device case defined by a body comprising an outer perimeter, and a sidewall attached to and extending about the outer perimeter of the body to define a recess, an inner case wall, and an outer case wall. The case includes a track attached to the outer case wall, wherein the track comprises a pair of parallel ridges on either side of a groove; and wherein each pair of ridges comprises at least one recess. The system includes a protrusion attached to an accessory, wherein the protrusion is sized and shaped to be releasably received within the groove, and wherein the at least one recess locks the protrusion into position within the groove. The accessory is releasably received within the groove at any desired location on the at least one track.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the system comprises at least one electrical contact area along the at least a portion of the length of the track.

In some embodiments, the at least one electrical contact area comprises at least one spring-loaded contact.

In some embodiments, the system comprises two or more tracks arranged parallel, perpendicularly, or angled relative to at least one other track.

In some embodiments, the groove is configured to allow the protrusion to be inserted in a horizontal or vertical orientation.

In some embodiments, the presently disclosed subject matter is directed to a method of releasably attaching one or more accessories to a device case. The method comprises attaching a protrusion to an accessory to be releasably attached to a device case, wherein the protrusion is sized and shaped to be received within the groove of a device case. The device case comprises: a body comprising an outer perimeter; a sidewall attached to and extending about the outer perimeter of the body to define a recess, an inner case wall, and an outer case wall; and a track attached to the outer case wall, wherein the track comprises a pair of parallel ridges on either side of a groove; wherein each pair of ridges comprises at least one recess. The method includes removably positioning the protrusion within the groove of the track ridge, wherein the at least one recess locks the protrusion in place on the track for a desired amount of time.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the groove has a T, triangular, trapezoidal, round, squared, diamond, pentagonal, hexagonal, cross, or abstract cross-sectional shape.

In some embodiments, the groove is configured to allow the protrusion to be inserted in a horizontal or vertical orientation.

In some embodiments, the device case comprises at least one electrical contact area along the at least a portion of the length of the track.

In some embodiments, the at least one electrical contact area comprises at least one spring-loaded contact.

In embodiments, an electronic device case includes a body that defines an interior space for holding an electronic device. The case also includes a track attached to a side of the body and comprising first and second rails. The rails each define a protrusion that extends substantially along a length of the track. The protrusion of the first rail and the protrusion of the second rail extend in substantially opposing directions. The case also includes a locking mechanism comprising a resilient member that engages the first and second rails for biasing the first and second rails in a first position for holding an accessory. The resilient member resists movement of the first and second rails to a second position for release or receipt of the accessory.

In embodiments, an electronic device case includes a body that defines an interior space for holding an electronic device. The case also includes a track attached to a side of the body and comprising first and second rails. The rails each define a protrusion that extends substantially along a length of the track. The protrusion of the first rail and the protrusion of the second rail extend in substantially opposing directions. Further, the first and second rails are configured to engage a locking mechanism of an accessory. The accessory defines first and second portions that are configured to hold to the first and second rails, respectively. The accessory further comprises a resilient member that engages the first and second portions for biasing the first and second portions in a first position for holding to the first and second rails, respectively. The resilient member resists movement of the first and second portions to a second position for release of the accessory from the first and second rails or attachment of the first and second portions to the first and second rails, respectively.

In embodiments, an electronic device case comprises a body that defines an interior space for holding an electronic device. The case also includes a track attached to a side of the body and comprising first and second rails. At least one of the rails defines a plurality of locking protrusions arranged along a length thereof. The locking protrusions are each configured to engage a corresponding feature of an accessory for holding the accessory in one of a plurality of positions along the length of the track.

In embodiments, a system includes an electronic device case comprising a body that defines an interior space for holding an electronic device. The case also includes a track attached to a side of the body and comprising first and second rails. The rails each define a protrusion that extends substantially along a length of the track. The protrusion of the first rail and the protrusion of the second rail extend in substantially opposing directions.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more 15 of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

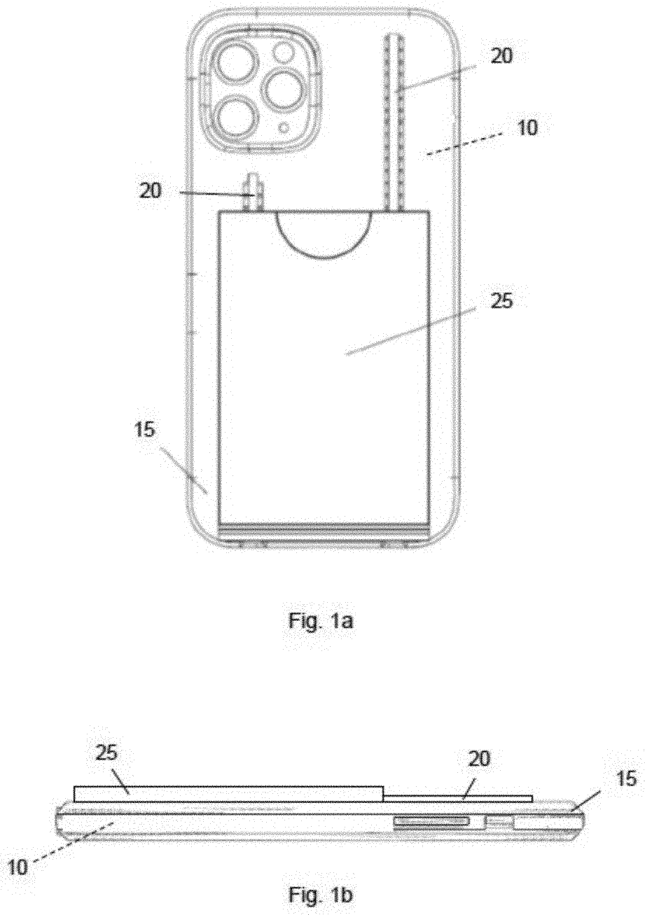

The presently disclosed subject matter is generally directed to a device case that provides for removable attachment of one or more accessories. FIGS. 1a and 1b illustrate one embodiment of a protective case used with device 10. Specifically, case 15 comprises one or more tracks 20 that allow a variety of accessories 25 to be attached and/or removed as desired by the user. In this way, one or more accessories can be added, removed, oriented, and/or arranged depending on a particular use of the device. Advantageously, each accessory locks into place on track 20 such that it is fully supported, as described in more detail herein below.

As set forth above, the disclosed attachment system includes case 15 used with device 10. The term “device” broadly refers to any of a wide variety of devices, including (but not limited to) cellular phones, smart phones, tablets, laptop computers, handheld gaming devices, GPS units, portable music players, gaming consoles, e-readers, cameras, digital cameras, smart watches, personal digital assistants, and the like. In some embodiments, device 10 is portable and can be carried in a user's hand or with a user's belongings (purse, briefcase, vehicle, etc.).

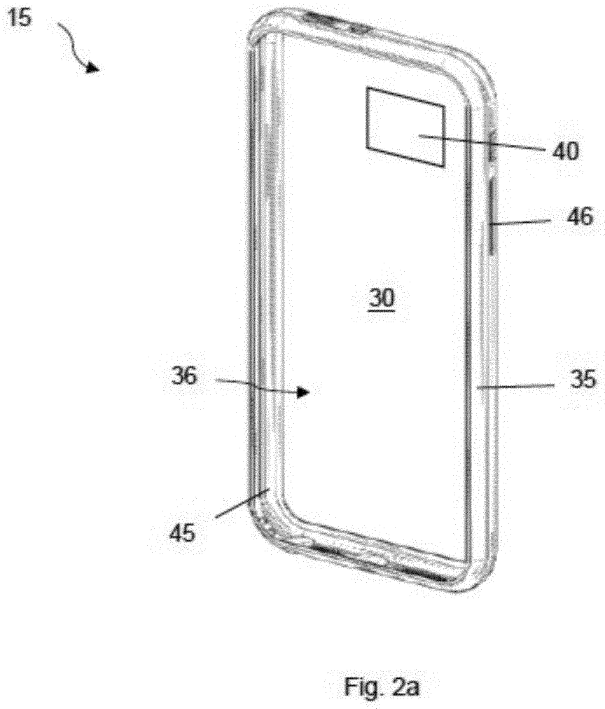

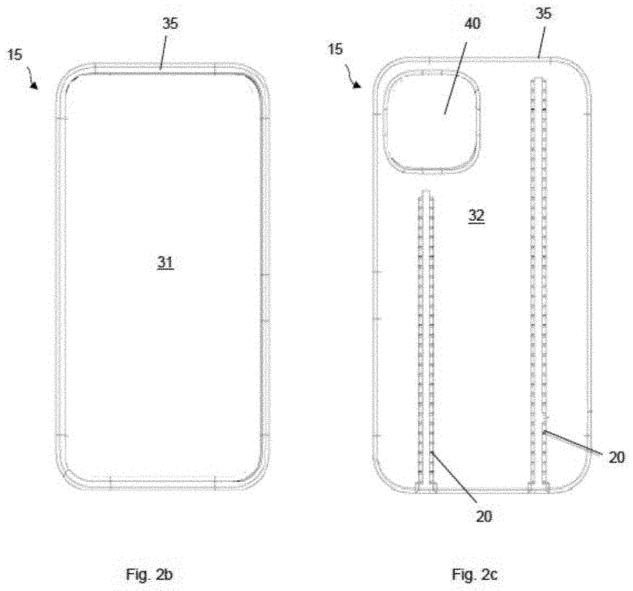

FIGS. 2a-2c illustrate one embodiment of case 15 that provides an overall enclosure and protection of device 10. Particularly, the case comprises panel 30 and sidewall 35 that join together to form cavity 36. Cavity 36 is sized and dimensioned to receive device 10. Panel 30 comprises inner face 31, opposing outer face 32, and two pairs of parallel side edges. Inner face 31 directly contacts one surface (e.g., the rear face) of a corresponding device. The panel outer face forms an exterior surface of the case. In some embodiments, the “rear face of a device” can refer to the face that the user does not interact with. For example, the rear face of a smart phone is the face opposite the viewing screen. The panel is sized and shaped to conform to the back face of device 10. Thus, panel 30 can be substantially flush against the back face of a device.

In some embodiments, panel 30 can include at least one aperture 40 sized and shaped to accommodate a corresponding feature in device 10. For instance, the aperture can be configured to align with a camera lens located on the rear face of the device when the device is seated within the case. It should be appreciated that aperture 40 can be positioned at any suitable location and can be configured in any desired shape and size.

Further, any number of apertures can be included on case 15. However, it should be appreciated that aperture 40 is optional and the disclosed case can be configured without an aperture.

Sidewall 35 is formed about the perimeter of panel 30 to retain the device within the case. In some embodiments, sidewall 35 can include groove 45 configured to receive and retain a lateral edge of device 10. In this way, the sidewall prevents device 10 from inadvertently being removed from the case. The sidewall can include at least one access 46 that allows a user to interact with a control button (e.g., volume, charging port) on the lateral edge of the device when the device is seated within case 15. Access 46 can be formed as an aperture, a raised portion, and/or a recessed portion. In this way, a user can interact with buttons and other functional elements of the device through case 15 as needed. For example, the access can be respectively associated with a power button and one or more volume buttons provided on a device (e.g., a tablet computer).

Case 15 can be constructed from any desired material. For example, the case can be constructed from silicone, polymeric material, rubber, metal, fiberglass, wood, fabric, or combinations thereof.

The case can be constructed using any suitable method known in the art, including (but not limited to) injection molding, blow molding, extrusion, coextrusion, compression molding, welding, and the like.

In some embodiments, the case can be constructed as a single piece that fits around device 10. In other embodiments, the case can be constructed from two or more pieces that releasably or permanently join together around the device.

As set forth above, at least one face of case 15 includes one or more tracks 20. The term “tracks” broadly refers to any attachment element that allows for the releasable coupling and/or locking of one or more accessories. In some embodiments, each track 20 is permanently attached to one face of case 15, such as outer face 32. The track can be permanently attached using any known method, such as (but not limited to) the use of adhesive, welding, thermoforming, mechanical elements (e.g., screws, bolts, clips), or combinations thereof. Thus, in some embodiments, the tracks are integrated into the case.

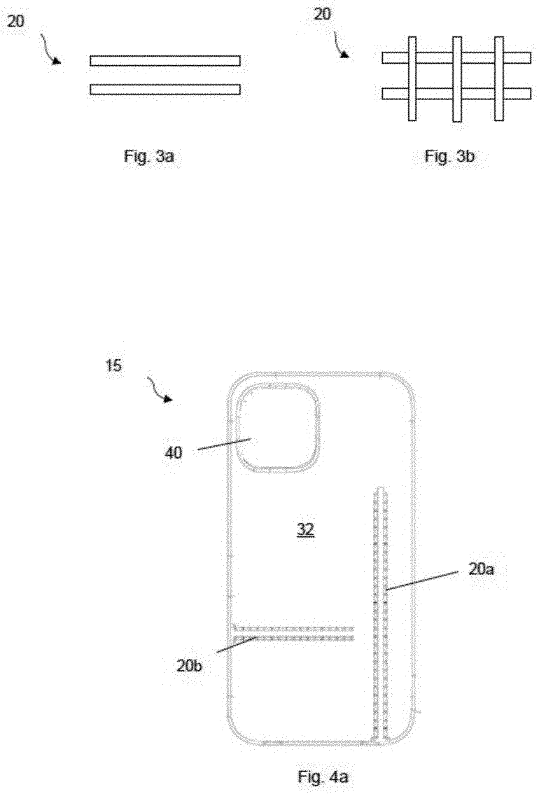

Alternatively, track 20 can be releasably attached to the case, such as in embodiments wherein only one track or a portion of one track is needed. The track can be releasably attached to the case using any known method, such as (but not limited to) the use of magnets, hook-and-loop closures, snaps, and the like. In this way, the location of track 20 can be customized by the user as desired or needed for a particular application. Thus, if a user intends to only carry a single small accessory, he can attach a correspondingly-sized track to rear face 32. Therefore, a user can customize tracks 20 as desired (e.g., both horizontal and vertical tracks added as needed for a selected number of accessories), as shown in FIGS. 3a and 3b. In this way, existing cases can be easily retrofit to include tracks for the releasable attachment of accessories.

Tracks 20 can be constructed from any desired rigid or semi-rigid material, such as (but not limited to) metal (e.g., stainless steel, aluminum, copper), polymeric material, wood, composite material, or combinations thereof.

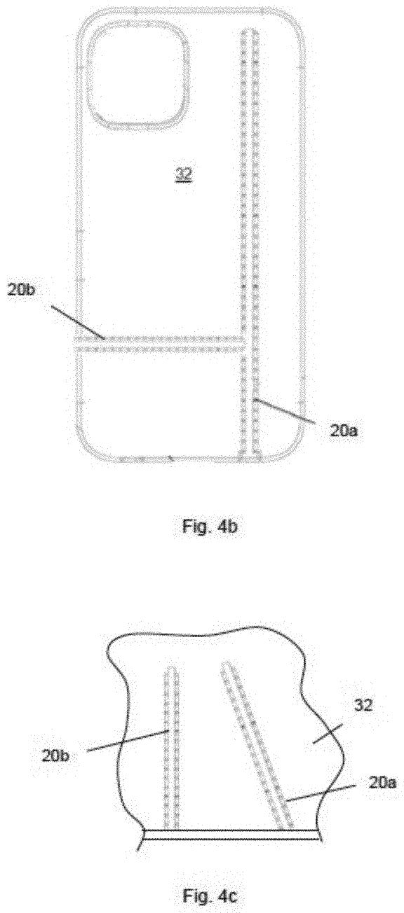

Case 15 can include any desired number of tracks 20. For example, in some embodiments, the case can include 1-10 tracks (e.g., 1, 2, 3, 4, 5, 6, 7, 8, 9, or 10). However, the presently disclosed subject matter is not limited and the case can have more than 10 tracks. When case 15 includes more than one track, the tracks can be arranged in parallel, as shown in FIG. 2c. However, the presently disclosed subject matter is not limited and the tracks can be arranged in any configuration relative to another track. For example, FIGS. 4a and 4b illustrate tracks 20a and 20b configured perpendicularly and T-shaped relative to each other. However, tracks 20 are not limited to parallel and perpendicular configurations, and can be angled relative to each other, as shown in FIG. 4c. The term “angled” can refer to any angle, such as an acute or obtuse angle. Thus, the tracks can be angled relative to each other or to the horizontal or vertical at least about (or no more than about) 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. Thus, the tracks can be configured in any way that allows for linear movement in at least one direction.

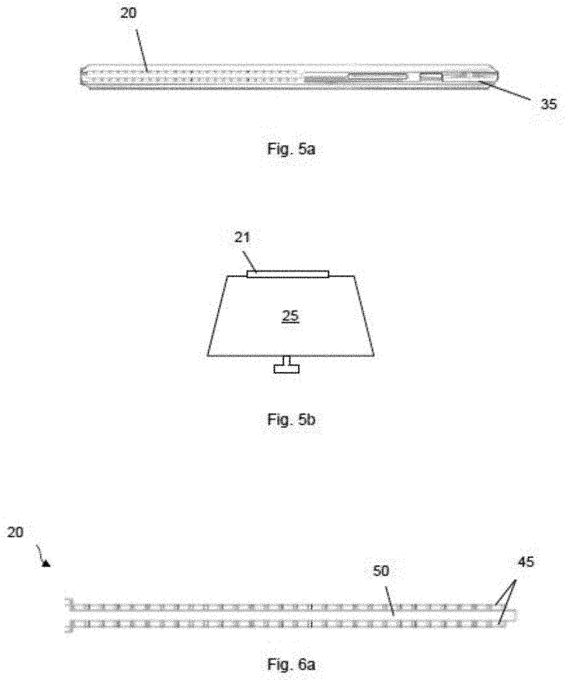

Although depicted on rear face 31 of the case, one or more tracks can be configured on any face of the case. For example, FIG. 5a illustrates one embodiment of case 15 comprising track 20 configured on an outer face of sidewall 35.

In some embodiments, one or more accessories can include track(s) to accessorize the accessories. Particularly, FIG. 5b illustrates one embodiment of accessory 25 comprising accessory track 21. The accessory track allows for the releasable connection of one or more additional accessories.

As set forth above, track 20 can include any configuration that provides for the attachment, locking, and release of a desired accessory. As illustrated in FIGS. 6a and 6b, track 20 includes a pair of parallel raised ridges 45 on either side of central groove 50. Each groove provides an opening in track 20 through which a corresponding portion of an accessory is received. In some embodiments, the accessory can move as desired by the user along track 20 to a desired location.

Ridge 45 can have any desired height 41 or width 42, such as about 0.05-1 inches. Thus, each ridge can have a height and/or width of at least about (or no more than about) 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1 inch. However, the presently disclosed subject matter is not limited and the ridge can have a height and/or width greater or smaller than the ranges given herein.

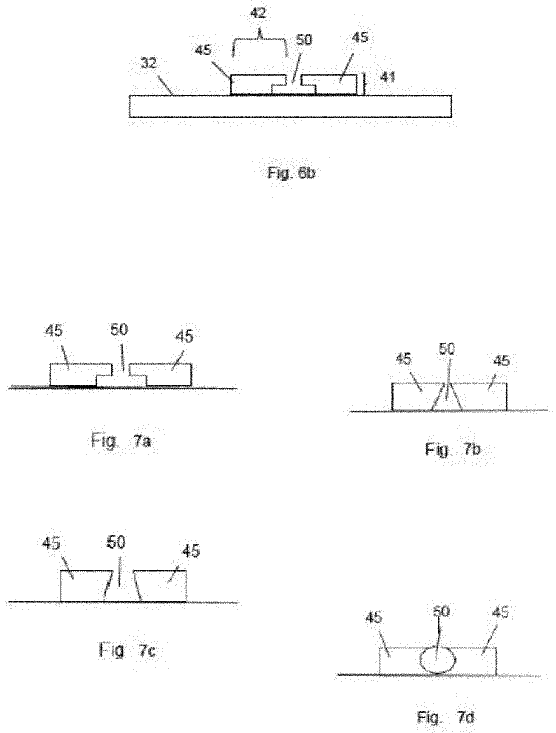

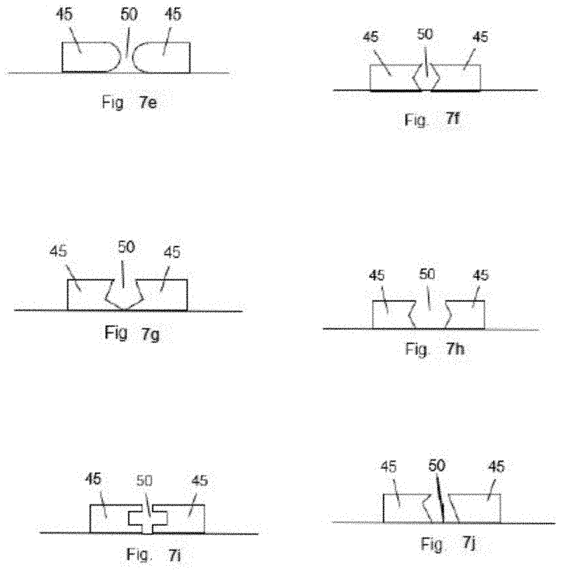

Groove 50 can have any desired cross-sectional shape, such as (but not limited to) a T-shape as shown in FIG. 7a, triangular shape as shown in FIG. 7b, trapezoidal shape as shown in FIG. 7c, rounded shape as shown in FIGS. 7d and 7e, diamond shape as shown in FIG. 7f, pentagonal shape as shown in FIG. 7g, hexagonal shape as shown in FIG. 7h, cross shape as shown in FIG. 7i, or abstract shape as shown in FIG. 7j. It should be appreciated that the cross-sectional shape of groove 50 (and corresponding ridges 45) are not limited and can be configured in any desired shape. In some embodiments, the groove can include at least one tapered side wall. It should further be appreciated that groove 50 can be configured in any length, any width, any depth, and any shape.

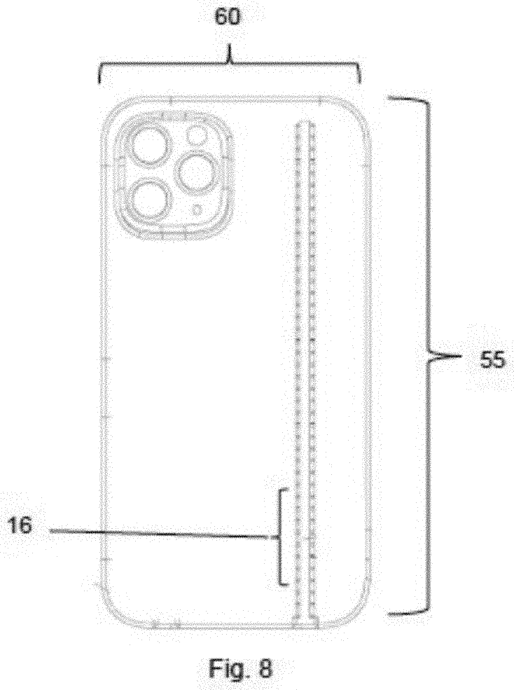

Track 20 can be configured in any desired length and width, depending on the length and/or width of the corresponding device. In some embodiments, track 20 can span approximately the full length 55 and/or width 60 of case 15, as shown in FIG. 8. The term “length” refers to the longest distance in the longitudinal direction. The term “width” refers to the longest distance perpendicular to the length. Alternatively, one or more tracks can span about 10-95 percent the length and/or width of a case. Thus, the track can span at least about (or no more than about) 10, 15, 20, 25, 30, 35, 40, 45, 50, 55, 60, 65, 70, 75, 80, 85, 90, or 95 percent of the length and/or width of case 15.

In some embodiments, the track can include electrical contact area 16 along the at least a portion of the length of the track. The electrical connection can be used to direct power from an electronic accessory to the electronic device, such as an extra battery to charge the electronic device. Alternatively, the electrical contact area can direct power from the electronic device to the accessory to power the accessory. Moreover, the case (using the track system) can direct power from a power source on or within the case to an accessory along the track, bypassing the electronic device all together. In some of the methods described, the electronic accessory can be charged at the same time as the electronic device.

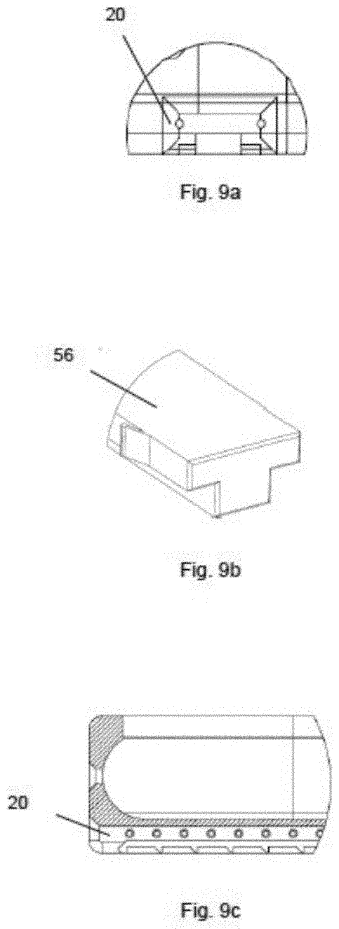

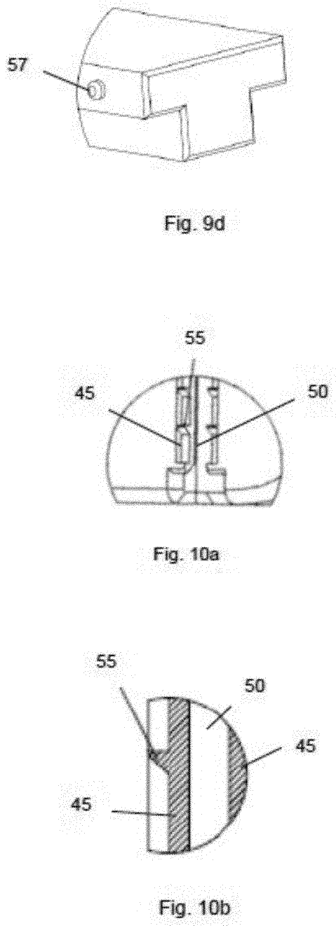

The electrical contact area on the case can be a solid surface along the edge of track 20, where there is a positive and negative contact area for power. The contacts can be in a single track as shown in FIG. 9a or on separate tracks. In some embodiments, the mating shape can include spring-loaded contact 56 where a connection can be made along the track, as shown in FIG. 9b. However, it should be appreciated that the contact is not limited to spring-loaded embodiments, and that any configuration that allows connection to be made along the track can be used. Alternatively, connections can be made at multiple points along track 20 corresponding to locking positions, as shown in FIG. 9c. Optionally, these points can be recessed to protect the contact area and to prevent shorting. The mating shape can have a spring loaded contact 57, similar to an electric pogo pin, that makes contact with the contact area on a track at a specific point, as shown in FIG. 9d. However, it should be appreciated that the male shape can have multiple contacts in any desired configuration.

The contact tracks in both embodiments can be manufactured on a printed circuit board (PCB) and inserted or molded into the case. Optionally, the PCB can also include a microprocessor, BLUETOOTH® transmitter/receiver, and/or other electrical components to enhance the functionality of the case and the accessories.

The singular contact shown in FIGS. 9a and 9b can provide power, while the individual contacts shown in FIGS. 9c and 9d can provide more functionality (e.g., known positioning of the accessory that is inserted by identifying individual connections rather than a singular one). The connections can provide more than just power; multiple pins can send and receive data or other information through direct connection to the electronic device, similar to a USB that has positive power, negative power, positive data, and negative data. The pins are not limited to the example above and can include any pin out connections (such as a USBC connection, etc.). These connections can allow the electronic device to connect to the case and accessories. It should be noted that the individual pin locations, in the example of the data transmission above, are not limited to a singular point but can be multiple points along the track. This is analogous to a USB strip or similar where multiple accessories can be added to communicate with electronic device.

In some embodiments, when an accessory is inserted into track 20, the rail system along with electronics embedded in the case have the capability of interacting with accessories through sensing, actuation, and/or control to describe and analyze a situation, and make decisions based on the available data in a predictive or adaptive manner, thereby performing smart actions. In one example, the position can be known and displayed on an app within the electronic device. The app can recognize which accessory has been attached and provide logic or data transmission to and from. For example, if an extra battery was inserted in the track along with chargeable earphones, the user could instruct the app to automatically engage the battery to charge the phone when the phone gets below 20%, use the phone power to charge the headphones when above 80% or simply turn it on and off when needed. This data transfer has many useful features such as expanding memory, transferring data from the electronic device to an SD card or USB through an accessory, accessing multiple video game cartridges, adding BLUETOOTH® transmitters to control multiple devices rather than a singular one etc. This could also be used for a docking device connection or connecting a phone to a gaming controller, virtual reality device where the tablet or phone could be used as a screen and external controls, buttons, features could be added.

Each ridge can include one or more recesses 55 that allow an accessory to be locked into place on the track. Specifically, the recesses provide a locking feature at specific set points for attachment of one or more accessories. FIGS. 10a and 10b illustrate one embodiment of ridge 45 comprising a series of recesses 55. The recesses can be uniformly or non-uniformly placed along the length (or a portion of a length) of the ridge. Any number of recesses can be included on a particular ridge. Further, the recesses can be configured in any desired size or shape as desired by the user. As described in detail below, each recess allows a corresponding accessory to be locked into place at a certain location on track 20, allowing for maximum configurability.

In some embodiments, the recesses function similar to a ratchet and pawl mechanism. The term “ratchet” refers to a mechanical device that allows continuous linear or rotary motion in at least one direction, while preventing motion in the opposite direction. The term “pawl” refers to any of a wide variety of curved or shaped bars or levers that include a free end that engages with a ratchet such that the ratchet can move in one direction. As illustrates in the Figures, the ratchet is flat and configured on case 15 and the pawl mechanism is positioned on the accessory. When inserted into track 20, the accessory can freely move in one direction where the locking mechanism inclines on a ramp. At the top of the ramp, the locking mechanism falls to a flat side of the ramp, thereby locking it into place until the locking mechanism is lifted, as illustrated in FIG. 10b. It should be appreciated that the shape of locking mechanism is not limited.

One or more accessories cooperate with tracks 20 to allow customization of case 15. The term “accessory” refers to any desired element that can releasably attach to track 20. Suitable accessories can therefore include (but are not limited to) a wallet, key, key card, keychain, pocket knife, earbuds, writing utensil, medication bottle, coin purse, flashlight, tape measure, photograph frame, notepad, watch, money clip, card holder, laser pointer, tool (screwdriver, bottle opener, tweezers, etc.), and the like. In some embodiments, the accessories can include non-function item(s), such as buttons, pins, patches, and other adornments that allow a user to express his personality or interests. Accessory 25 can therefore include any item capable of attaching to case 15.

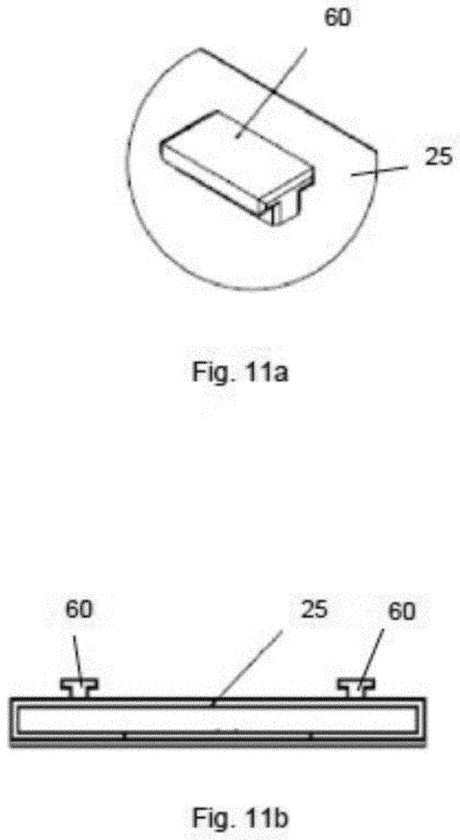

Accessory 25 includes one or more protrusions 60 that cooperates with track 20. Specifically, the protrusion is sized and shaped to fit into track groove 50. For example, FIGS. 11a and 11b illustrate one embodiment of accessory 25 comprising protrusion 60 configured in a “T” shape. Protrusion 60 can be permanently or releasably attached to one surface of the accessory, such as through the use of adhesive, welding, snap-fit attachment, pressure-fit attachment, magnets, hook-and-loop closures, mechanical elements (screws, clips, etc.), and the like.

Protrusion 60 can be configured in any desired size and/or shape, so long as it can 10 be retained within track groove 50. For example, the protrusion can connect to groove 50 via a dovetail connection. However, it should be appreciated that a tapered dovetail connection is only one of many possible connections. In some embodiments, the protrusion can have about the same or slightly smaller size and/or shape as groove 50 to allow for a snug fit when the protrusion is received within the groove. In some embodiments, the protrusion can have a squared shape to prevent rotation of the accessory. Alternatively, the protrusion can have a rounded shape when the user desires to rotate the accessory.

Accessory 25 can be constructed from any desired material, such as (but not limited to) wood, metal, polymeric material, rubber, fabric, or combinations thereof.

Accessories 25 can be arranged on track 20 horizontally and/or vertically. The term “horizontally” refers to any direction parallel to the level floor. The term “vertically” refers to the direction perpendicular to the level floor. The accessories can be configured, added, and/or removed based on the preference of the user in either a horizontal or vertical manner. Specifically, accessories 25 can be positioned at any desired location on track 20 by inserting protrusion 60 into groove 50. As a result, case 15 can be customized with one or more accessories as needed.

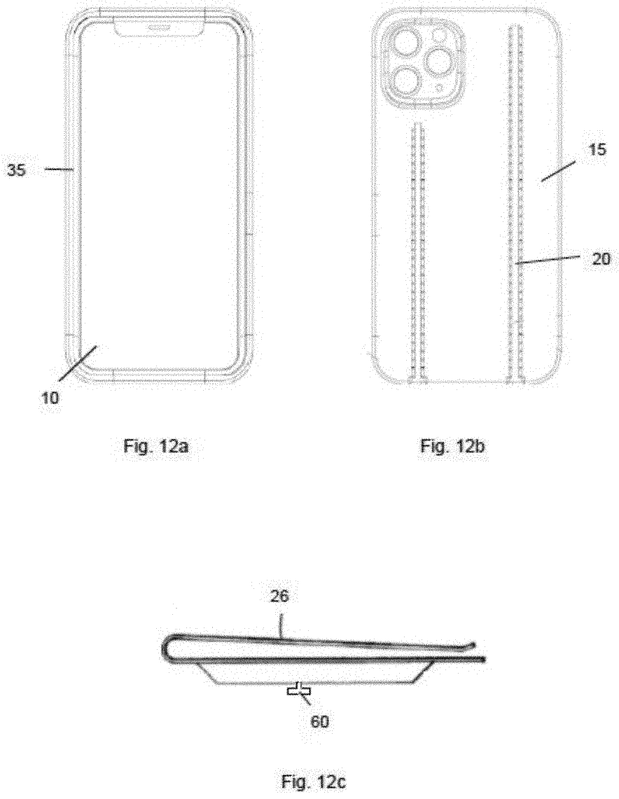

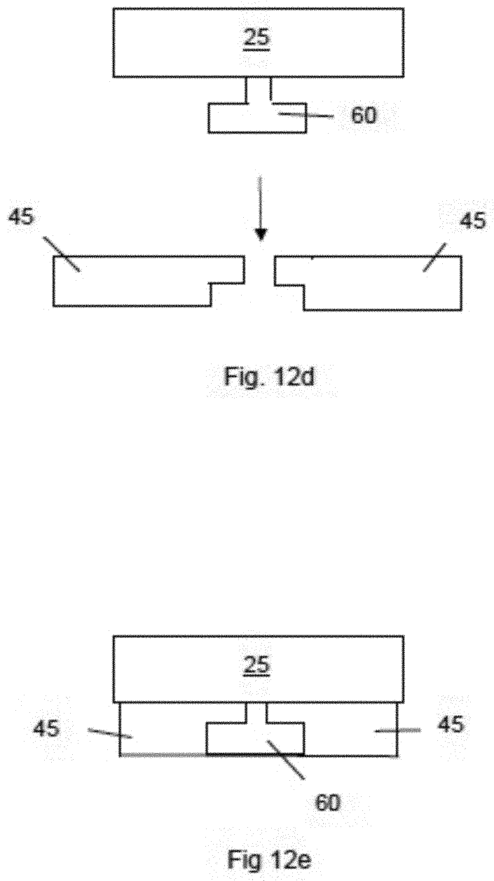

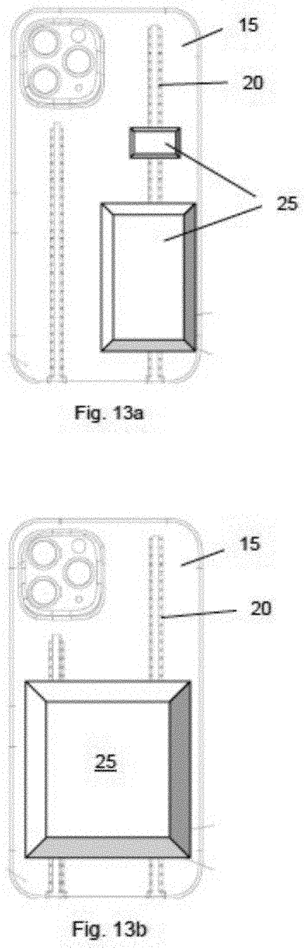

In use, case 15 is configured around a corresponding device 10 using methods well known in the art, as shown in FIGS. 12a and 12b. In some embodiments, the case is constructed from an elastomeric material that allows the case to stretch and adjust about the exterior of the device. In other embodiments, the case is assembled using two or more elements that join together around a corresponding device. As shown, one or more tracks are attached to one surface of cover 15, such as (but not limited to) the back face of the cover.

One or more protrusions 60 are attached to a desired accessory as desired by the user. The protrusion can be permanently attached to the accessory, such as through the use of adhesive, welding, mechanical attachments (e.g., screws, bolts) or molded, machined, and the like so that the protrusions and the accessories are a single piece. Alternatively, the protrusion can be releasably attached to accessory 25, such as through the use of hook-and-loop closures, magnets, clips, and the like. FIG. 12c illustrates one embodiment of an accessory (money clip 26) with attached protrusion 60. The protrusion can be attached to any surface of the accessory.

The protrusion can then be inserted into the groove of a corresponding track, as shown in FIGS. 12d and 12e. The size and shape of the protrusion are accommodated within groove 50. In some embodiments, protrusion 60 and groove 50 have about the same size and shape to provide a snug fit and reliably retain the protrusion within the track system. In some embodiments, the size of the protrusion is slightly smaller than the size of groove 50. As described above, one or more recesses 55 along track 45 are spaced to allow the user to lock accessory 25 into the track. In some embodiments, protrusion 60 is inserted into track 45 at the desired location of recess 55. Optionally, when the protrusion placed in a locked position with respect to the track, there may be an audible sound (e.g., a clicking or snapping sound) to indicate to the user that the accessory is properly locked in place. In some embodiments, one or more accessories can be deposited on a single track, as shown in FIG. 13a. Alternatively, one or more accessories can be configured on adjacent tracks, as shown in FIG. 13b. In some cases, the track will be large enough to hold multiple accessories. In such cases, when the track has extra capacity, the track can provide additional storage for more than one accessory.

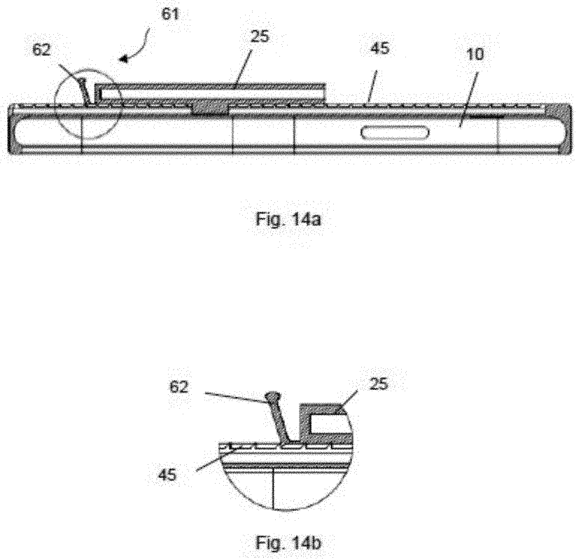

When a user desires to remove the accessory from case 15, he simply unlocks the accessory to remove protrusion 60 from track 50, as shown in FIGS. 14a and 14b. In some embodiments, this can be accomplished by applying light pressure to lock 61 on the accessory where pawl 62 becomes disengaged and allows the accessory to slide to a new position and/or be removed altogether. The term “pawl” can refer to any element that allows an accessory to be removably attached to a track. Further, pawl 62 is not limited to the embodiment shown and can be disengaged by squeezing, pushing, light touch, etc. When pressure is released, the pawl reengages and locks. The lock mechanism is not limited and can include any lock/release design. For example, in some embodiments, the lock can include a spring detent feature that can allow the accessory to slide when pressure is applied to the accessories for easier removal when desired. When pressure is applied, the protrusion is released from recess 55 and track 50. The accessory can then be removed and replaced with a different accessory as needed.

The disclosed case provides many benefits and advantages. For example, the case can be customized with a variety of different accessories, depending on the desires of the user and/or a particular situation.

Case 15 protects device 10 from damage due to accidental dropping or exposure 15 to dirt, liquids, and the like.

The disclosed case increases convenience for the user by providing accessories 25 within easy reach. The user does not have to search a second location to retrieve the accessory.

Because a desired accessory is close at hand on case 15, there is a decreased 20 likelihood that the accessory will become misplaced or lost.

Further, the disclosed case is relatively inexpensive to manufacture, and is safe and easy to use.

In addition, the disclosed case is not limited to a single use. Rather, a wide variety of different uses (and different accessories) can be used with the disclosed case.

Compared to other cases that may include/incorporate one accessory, such as a wallet, this does not limit the case to a singular use and the uses can be interchanged.

In some embodiments, the case can be attached to a mounting device and/or accessory that secures the phone with a mechanical lock, adhesives, elastic, and the like. Particularly, prior art devices typically require the attachment of accessories through the use of adhesives, friction or clamps, and/or elastic elements (e.g., rubber band) around the corners. The disclosed rail system is more secure because it does not rely on adhesives that can degrade friction and do not hold well and/or the use of elastic that is unreliable.

The case could be attached to a mounting device/accessory that better secures the phone with a mechanical lock versus friction, adhesives or elastic means.

The accessories, also containing the rail attachment method, could allow bundling of the accessories together, as to allow separation from the case, while maintain security of the bundle.

In some embodiments, one or more accessories can include a track as described 10 above. Such embodiments allow the bundling of accessories together to allow the accessories to separate from the case, but also maintain security of the bundle.

Accessories could be grouped tougher depending on the user's goals. For example, a daily “accessory pack” could include a wallet, car keys, and a mount. A boating “accessory pack” could include a floatation device, bottle opener and small scissors for cutting fishing line etc.

The disclosed system can provide for the grouping of accessories together as desired by a user. For example, a daily “accessory pack” can be customized to include accessories used on a daily basis (e.g., wallet, car keys, mount). Further, a boating “accessory pack” can include a floating device, bottle opener, scissors, and the like.

The male/lock portion of the attachment method could be attached by any means necessary to any device such as sewn into clothing for runners or glued onto a bike helmet to function similar to a GOPRO® camera.

In some embodiments, one end of a chain or rope can be attached to the case (while the other end is attached to the user or another item) to provide an added layer of security, preventing or reducing the likelihood of theft and/or misplacement.

The disclosed case further allows a user to express his personality. Specifically, the user can customize the case with accessories that reflect the user's interests and/or identity. It is noted that an accessory can be any electronic device that can operate together with another electronic device or beneficial to attach to another electronic device via its case. Example accessories include, but are not limited to, speakers, camera, battery, lighting, temperature sensing device, humidity sensing device, barometric pressure sensing device, microphone amplifier, motion sensor, extra storage, credit card reader, plug adaptor (e.g, USBC, USB, Lightning, etc.), breathalyzer, distance sensor (e.g., laser, time of flight, ultrasonic, lidar, light sensor (e.g., UV, Infrared, visible light)), thermal camera, keypad, keyboard, joystick, other controllers, air quality sensor, gas sensor, GPS antenna, altimeter, machine learning camera, fingerprint sensor, radiation sensor, potentiometer, encoder, barcode scanner, muscle sensor, beam break sensor, projector, plug adaptors, blood sugar monitor, pulse oxygen reader, earbud holders, and the like.

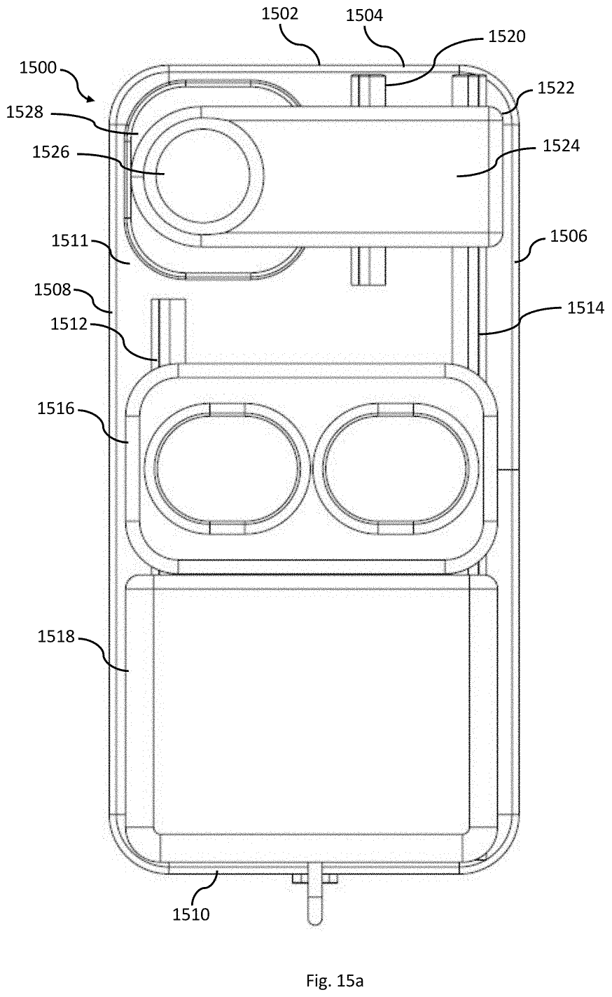

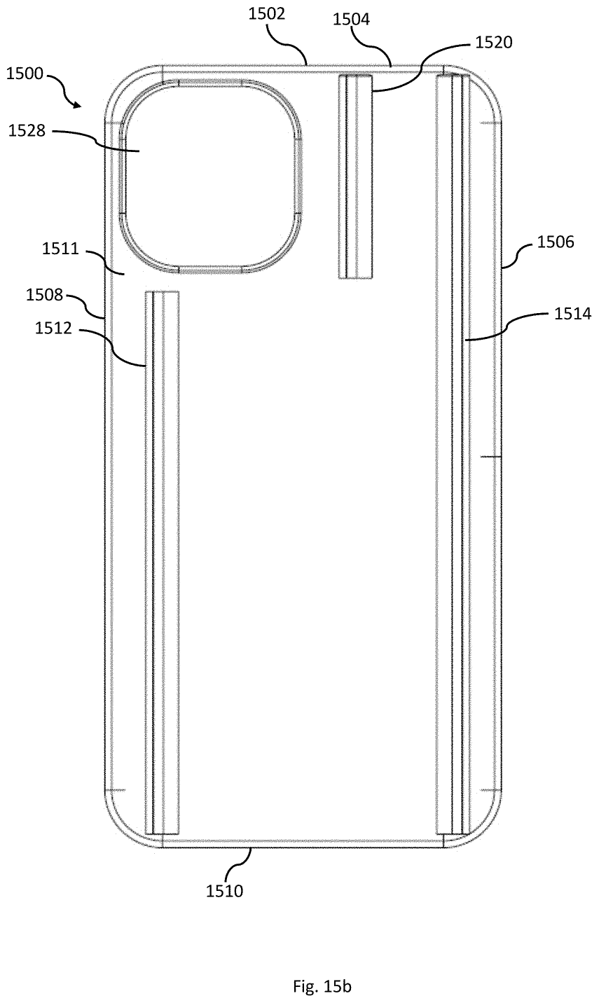

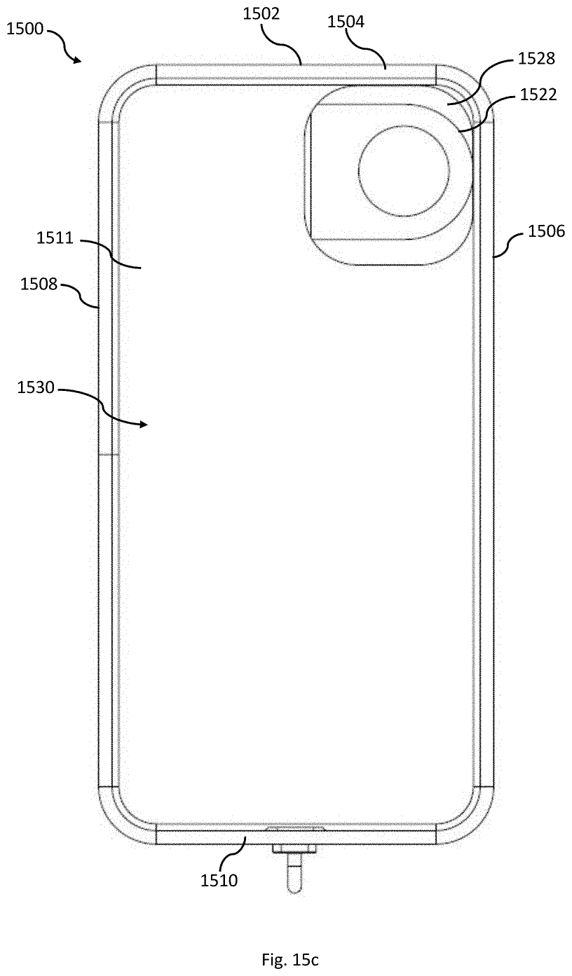

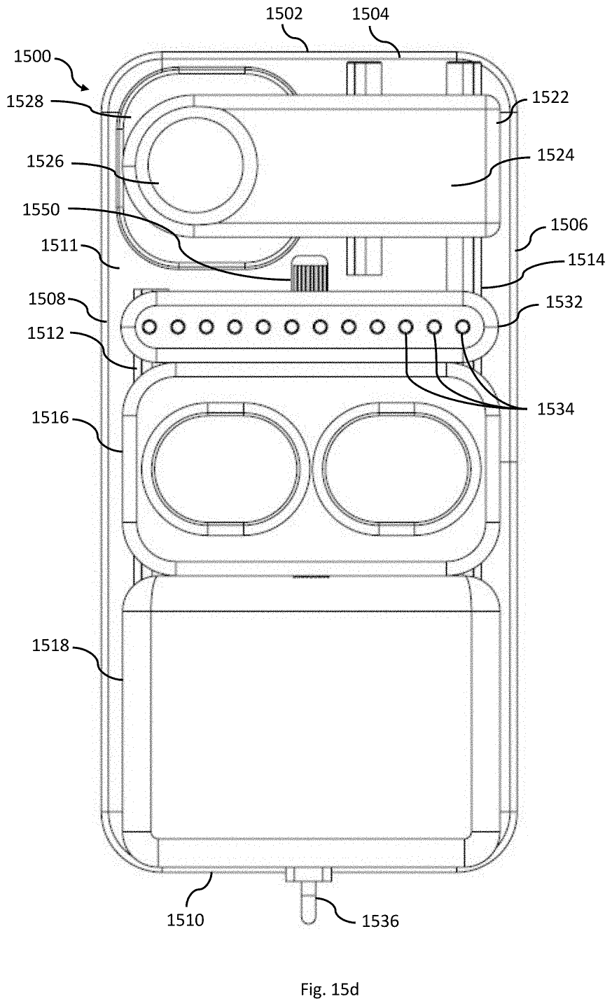

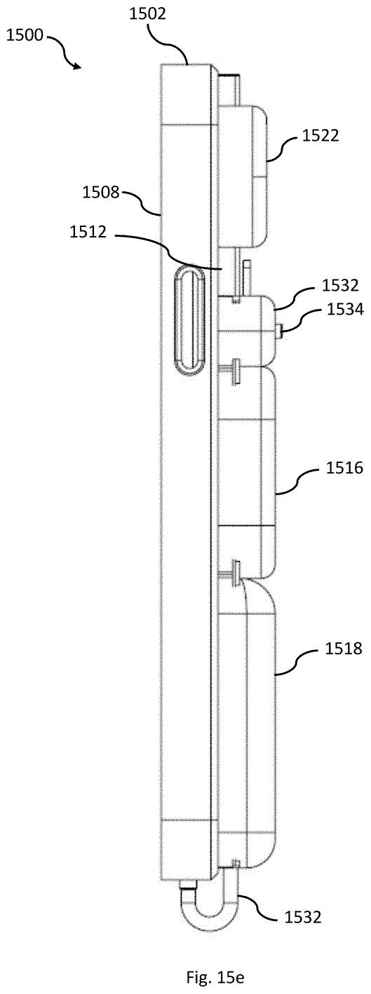

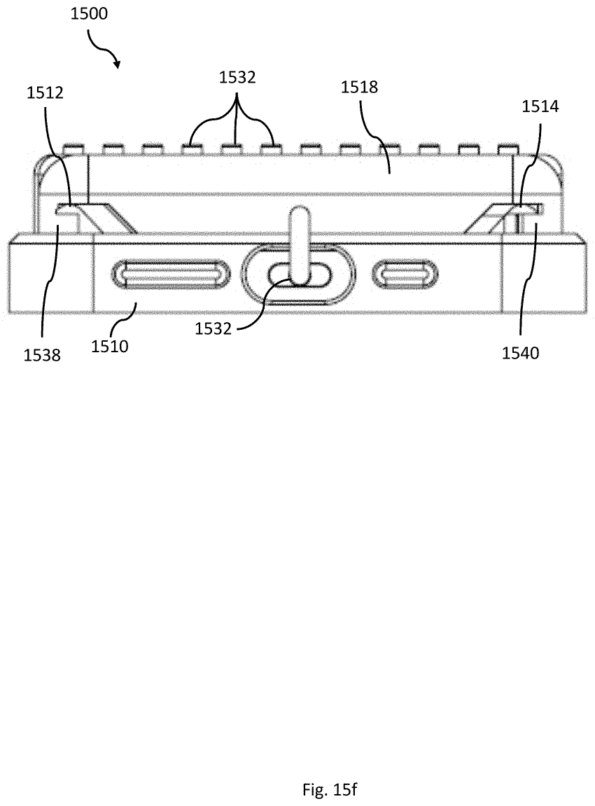

FIG. 15a illustrates a rear view of an electronic device case 1500 having a track for holding accessories in accordance with embodiments of the present disclosure. Referring to FIG. 15a, the electronic case 1500 includes a body 1502 that defines an interior space (not shown in this figure) for holding an electronic device (not shown in this figure). The body 1502 can define sides 1504, 1506, 1508, and 1510 that can hold, support, and protect the electronic device. Further, the sides 1504, 1506, 1508, and 1510 can define an opening (not shown in this figure) that opens to the front side of the electronic case 1500 for receiving the electronic device. A back side of the opening can be defined by a rear side 1511, which may be substantially flat in shape. The rear side 1510 can have edges that meet and be attached to the sides 1504, 1506, 1508, and 1510.

In this example, the electronic case 1500 shown in FIG. 15a is sized and shaped for holding a smartphone and described as such. However, it should be understood that the electronic case 1500 may alternatively be suitably sized and shaped to hold any other suitable electronic device such as a tablet computer.

With continuing reference to FIG. 15a, the electronic case 1500 includes a track attached to the rear side 1511. In this example, the track includes two rails 1512 and 1514, but may alternatively include any suitable number of rails. Rails 1512 and 1514 extend substantially along a length of the body 1502 between the upper end (wherein side 1504 is attached) and the lower end (where side 1510 is attached). In this example, rail 1514 extends nearly the entire length between the upper end and the lower end. Rail 1512, in this example, extends less distance than the length of rail 1514.

Rails 1512 and 1514 can cooperate to hold one or more accessories. In FIG. 15a, the rails 1512 and 1514 are holding accessories 1516 and 1518. Accessory 1516 is a speaker, and accessory 1518 is a battery. Any other suitable type of accessories can be held by the rails 1512 and 1514.

In this example, the speaker 1516 can be operatively connected to the electronic device for playing audio (e.g., music) from the electronic device. The speaker 1516 can be connected to the electronic device via a short range, wireless technology, such as BLUETOOTH® wireless technology. Alternatively, the battery 1518 can have electrical contacts integrated therein for a hardwired connection to the electronic device through which electrical signals can be transmitted for playing music via the speaker 1516.

Further in this example, the battery 1518 can be operatively connected to the electronic device for providing electrical power the electronic device.

In accordance with embodiments, the battery 1518 can be used as a backup to an electronic device (e.g., smartphone). Further, the battery 1518 can include all electronics for other accessories to allow for a small footprint of the other accessories. In an example, the battery 1518 may include wireless communication technology (e.g., BLUETOOTH® wireless technology) for communicating data with the electronic device, such as for interacting with an application (or “app”) residing on the electronic device.

Another rail 1520 is attached to the side 1510 and can cooperate with the rail 1514 to form another track near the upper end of the body. This other track (formed by the upper portion of rail 1514 and rail 1520) is narrower than the track formed by rail 1512 and a lower portion of rail 1514. As a result, the tracks can accommodate accessories having different sized mechanism(s) for attaching to the rails of the tracks as described in more detail herein.

In an example, a lens accessory 1522 can be held by the track formed by rails 1514 and 1520. The lens accessory 1522 can include an adjustable arm 1524 for holding a lens 1526 in front of a camera of the electronic device. The camera of the electronic device can be exposed through an opening 1528 of the side 1510. The lens accessory 1522 may be movable along the track to be moved to and held at different positions in the vertical direction for suitable positioning in front of the camera. Further, the arm 1524 may be adjustable in along a horizontal direction for suitable positioning in front of the camera.

FIG. 15b illustrates another rear view of the electronic device case 1500 shown in FIG. 15a without accessories being attached.

FIG. 15c illustrates a front view of the electronic device case 1500 shown in FIGS. 15a and 15b. Referring to FIG. 15c, the lens accessory 1522 can be seen through the opening 1582. Also, an interior space 1530 defined by the body 1502 for holding an electronic device is shown. This interior space 1530 is defined by surfaces of the sides 1504, 1506, 1508, 1510, and 1511.

FIG. 15d illustrates a front view of the electronic device case 1500 with an additional accessory 1532 being attached thereto via the rails 1512 and 1514. This additional accessory 1532 is a light bar having a plurality of light emitting diodes 1534. Also, it is noted that the accessories 1516, 1522, and 1532 can be electrically daisy-chained together for electrically powering the accessories. For example, an electrical connector 1550 can electrically connect accessory 1532 to accessory 1522 such that electrical power at accessory 1532 can be provide to accessory 1522. In this figure, the battery 1518 is shown as being connected to accessory 1516 such that the accessory 1516 can receive power from the battery 1518. The accessories can be suitably moved along the rail such that their respective connectors connect together. In addition, data communication can be shared among the accessories by the same connection. In an alternative, the battery may be absent and one of the accessories may be directly connected to the electronic device, such as by a cable 1536 as described further herein.

FIG. 15e illustrates a side view of the electronic device case 1500 shown in FIG. 15d. Referring to FIG. 15e, the battery 1518 can be operatively connected to an electrical power input (not shown) of an electronic device via a cable 1536 such that the battery 1518 can power the electronic device.

FIG. 15f illustrates a bottom view of the electronic device case 1500 shown in FIGS. 15d and 15e. Referring to FIG. 15f, the accessory 1518 defines two features 1538 and 1540 attached to its underside that are shaped and sized for gripping to the protrusions 1512 and 1514, respectively. These components are fitted together for a secure hold of the accessory 1518 by the case 1500. In addition, these components permit the accessory 1518 to be moved, by adequate force, along the track such that the accessory can be positioned as desired.

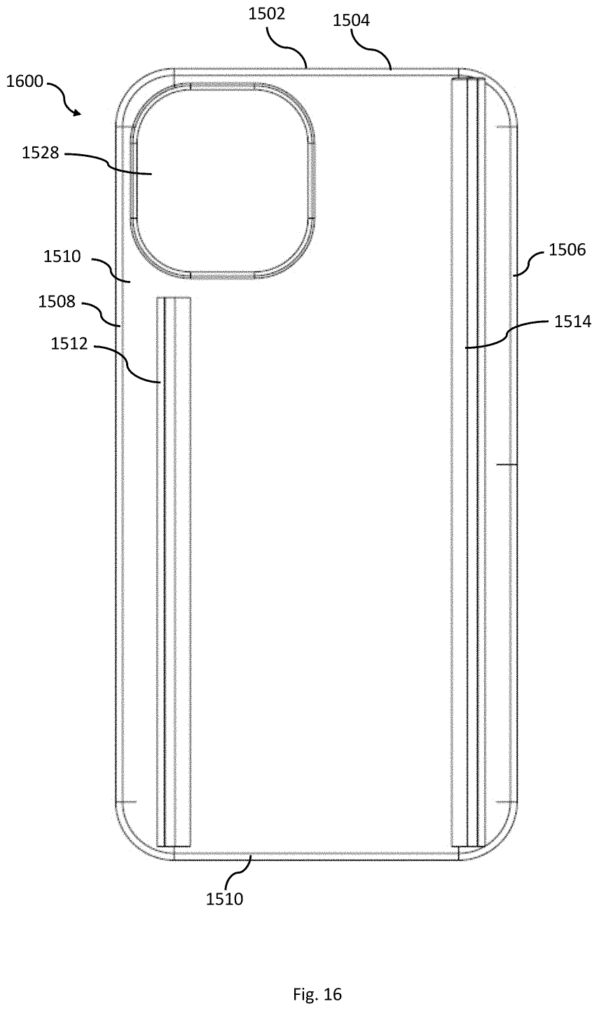

FIG. 16 illustrates a rear view of an electronic device case 1600 that is similar to the electronic device case 1500 shown in FIGS. 15a-15c. The electronic device case 1600 is similar except that it does not include the rail 1520 to form the upper track with rail 1514 as with the electronic device case 1500 shown in FIGS. 15a-15c.

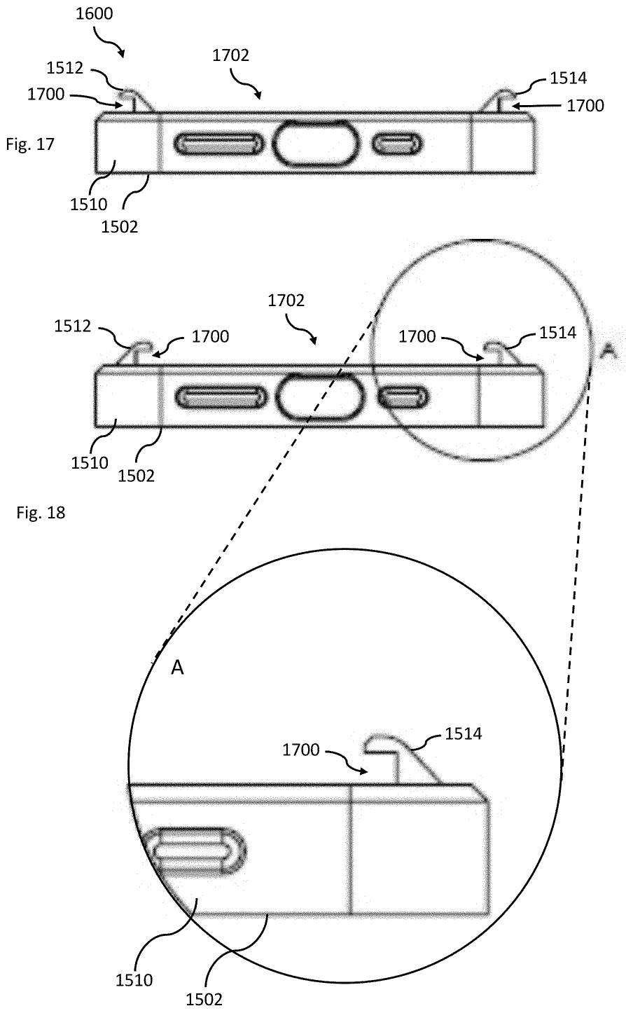

FIG. 17 illustrates a bottom view of the electronic device case 1600 shown in FIG. 16. Referring to FIG. 17, the rails 1512 and 1514 of the electronic device case 1600 are defined as protrusions attached to and extending from the back side 1510. In this example, the protrusions of the rails 1512 and 1514 are arcuate in shape, although it should be noted that the protrusions may alternatively be of any other suitable shape for implementing the functions of holding an accessory as described herein. Further, the protrusions of the rails 1512 and 1514 may each define a slot 1700 for engaging a corresponding protrusion of an accessory. It is noted that the rails (along with the slots of each) may extend substantially the length between an upper end and a lower end of the case 1700 such that an accessory may be placed anywhere along the length.

With continuing reference to FIG. 17, a space 1702 is defined by and between the rails 1512 and 1514. At least a portion of one or more accessories may be positioned within the space 1702 when the accessories are positioned of at least a portion of the accessory when the accessories are held by the first and second rails 1512 and 1514.

FIG. 18 illustrates a bottom view of another example electronic device case 1800. Referring to FIG. 18, this electronic device case 1800 is similar to the case 1600 shown in FIG. 17 except that the slots 1700 face an interior of the case 1800 towards the space 1702. A magnified portion A of the right side of the case 1800 is also shown in order to provide additional details.

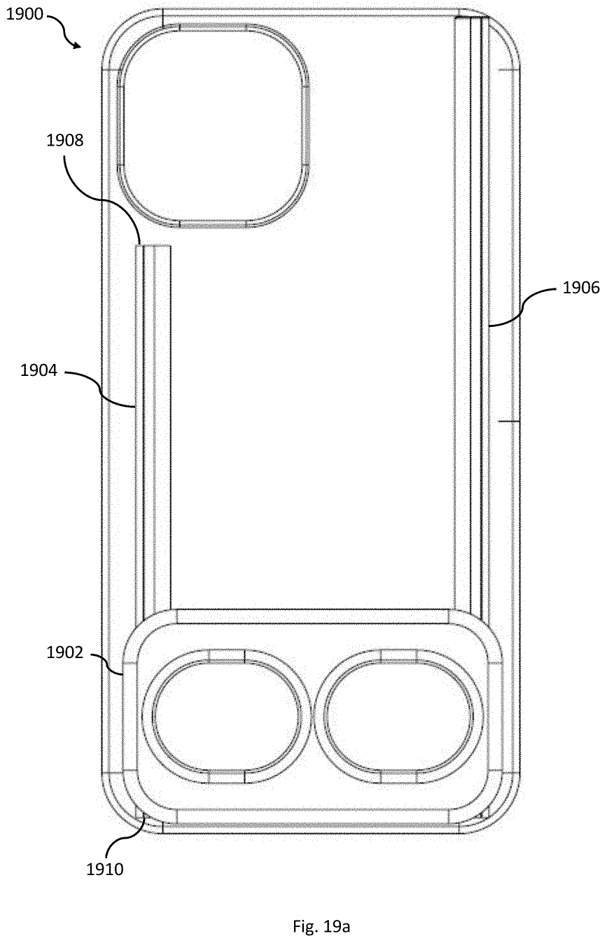

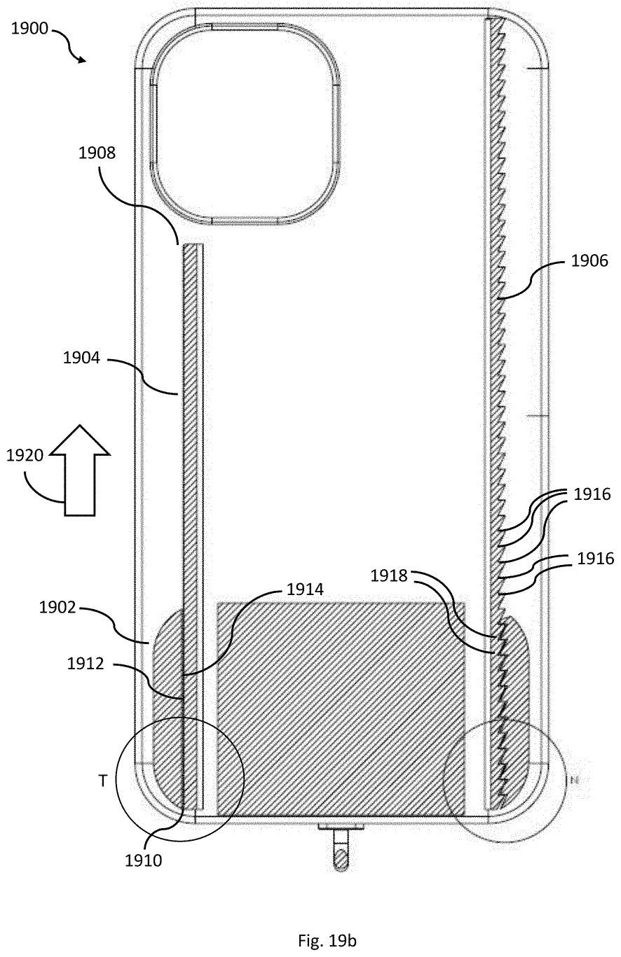

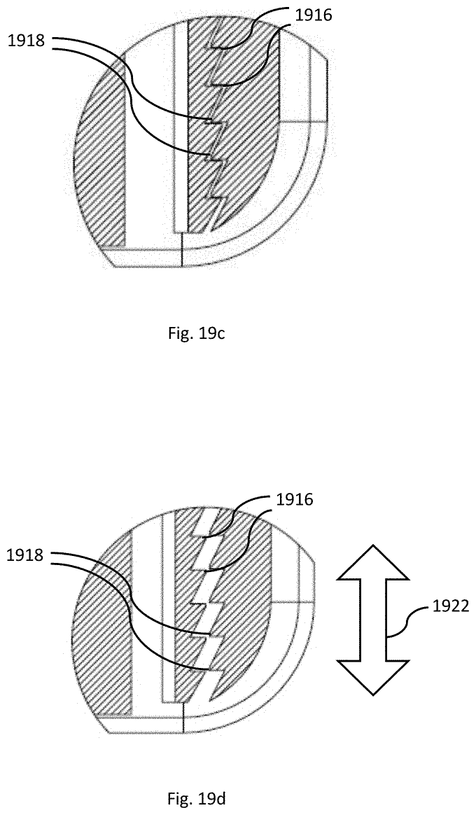

FIGS. 19a and 19b illustrate rear views of another electronic device case 1900 that demonstratestwo (2) different locking mechanisms for holding an accessory 1902 in a desired position along a length of the case 1900 in accordance with embodiments of the present disclosure. The case 1900 is similar to the case 1600 shown in FIG. 16, but the locking mechanisms are different.

Referring to FIG. 19a, the case 1900 includes has a track with rails 1904 and 1906 such that the accessory 1902 can be moved along the track and locked into a selected position anywhere along the length of rail 1902 between its upper end 1908 and lower end 1910. In this example, the accessory 1902 is a speaker but may alternatively be any other suitable type of accessory. It is also noted that two or more accessories may be selectively positioned along the track and locked into place.

Now turning to FIG. 19b, this figure depicts a cross-sectional view of the accessory 1902 and rails 1904 and 1906 in order to show the operation of the two different locking mechanisms. Particularly, rail 1904 can utilize the resistance to movement of the accessory 1902 along the track due to friction between a surface 1912 of the rail and a surface 1914 of the accessory 1902. The surfaces 1912 and 1914 can meet when the accessory 1902 is attached to the track in the position shown (or in another position along the track). Further, by the attachment in the shown position, the surfaces can exert a force on each other or one on the other such that the upward and/or downward movement of the accessory 1902 along the track is resisted. The force(s) can be generated due to a tightness of fit of the accessory 1902 on the rail 1904, or a locking mechanism on one or both of the rail 1904 or the accessory 1902 that causes the force onto the opposing surface.

Now turning to rail 1906, this rail defines locking protrusions 1916 (or serrations) that extend along a side and length of the rail 1906 for engaging corresponding protrusions (or other suitable features) of an accessory. As shown in FIG. 19, the protrusions 1916 can engage protrusions 1918 of the accessory 1902. The protrusions 1918 of the accessory 1902 are arranged along its side. By engagement of the protrusions 1916 and 1918, the accessory 1902 can be locked and held in place at a desired position along the length of the track. Further, the protrusions 1716 and 1918 are arranged and configured to permit the accessory 1902 to be moved along the track and locked into a selected position anywhere along the length of rail 1902 between its upper end 1908 and lower end 1910.

Further, in this example, the protrusions 1916 and 1918 are arranged such that the accessory 1902 can move only in an upward direction as indicated by arrow 1920. Movement in the direction opposing the direction of arrow 1920 is resisted due to the configuration of protrusions 1916 and 1918. The accessory 1902 can be received at the lower end of the track and moved upward to a position where it is desired to lock it into place. The aforementioned friction caused by the contacting surfaces 1912 and 1914 can resist movements in the direction of double arrow 1922 and the opposing direction as shown in the close-up views of FIGS. 19c-19f.

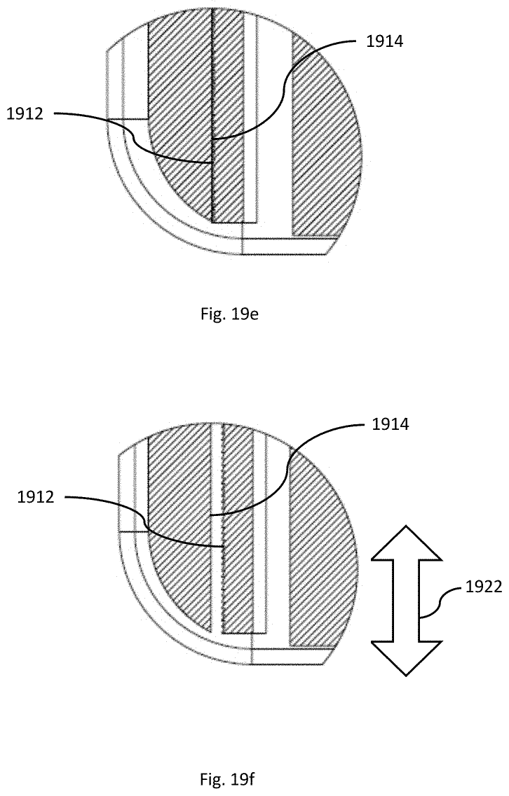

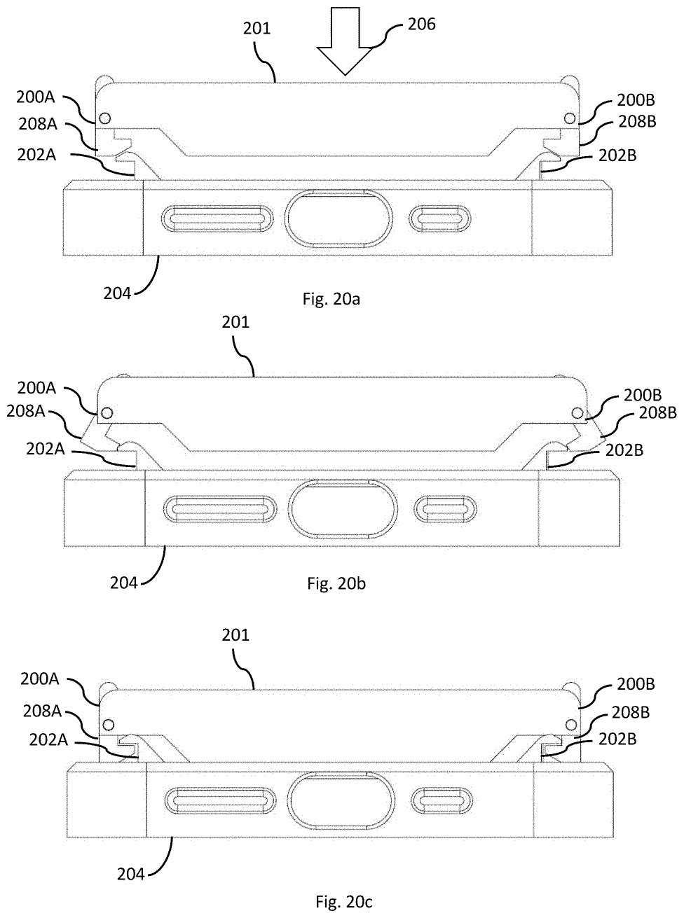

FIGS. 20a-20c are bottom views showing a sequence of using dual locking mechanisms 200A and 200B of an accessory 201 to engage and lock onto rails 202A and 202B, respectively, of an electronic device case 204 in accordance with embodiments of the present disclosure. Referring to FIG. 20a, this figure shows the locking mechanisms 200a and 200b of the accessory 201 spaced slightly apart from rails 202A and 202B. The locking mechanisms 200a and 200b can each include a biasing component for biasing the locking mechanisms 200a and 200b in the respective positions shown in FIG. 20a. The accessory 201 is shown in FIG. 20a as being aligned such that movement in a downward direction, as indicated by arrow 206, can begin the engagement of the locking mechanisms 200A and 200B with the rails 202A and 202B, respectively, as shown in FIG. 20b for locking the accessory 201 onto the track of rails 202A and 202B.

As shown in FIG. 20b, the locking mechanisms 200A and 200B include arms 208A and 208B with features for engaging and locking onto the rails 202A and 202B, respectively. Due to engaging the rails 202A and 202B, the arms 208A and 208B are deflected a pivot about respective axes to the respective positions shown in FIG. 20b. Now turning to FIG. 20c, this figure shows full engagement with the case 204 after the accessory 201 is further moved downward. In the position of FIG. 20c, the accessory is locked to the case and the biasing mechanisms of the locking mechanism 200a and 200b cause the arms 208A and 208B to move inward for gripping to the rails 202A and 202B, respectively. One or both of top portions 210A and 210B of the arms 208A and 208B, respectively, can be moved inward to cause their lower portions to release the arms 208A and 208B from gripping the rails 202A and 202B such that the accessory 201 can be released.

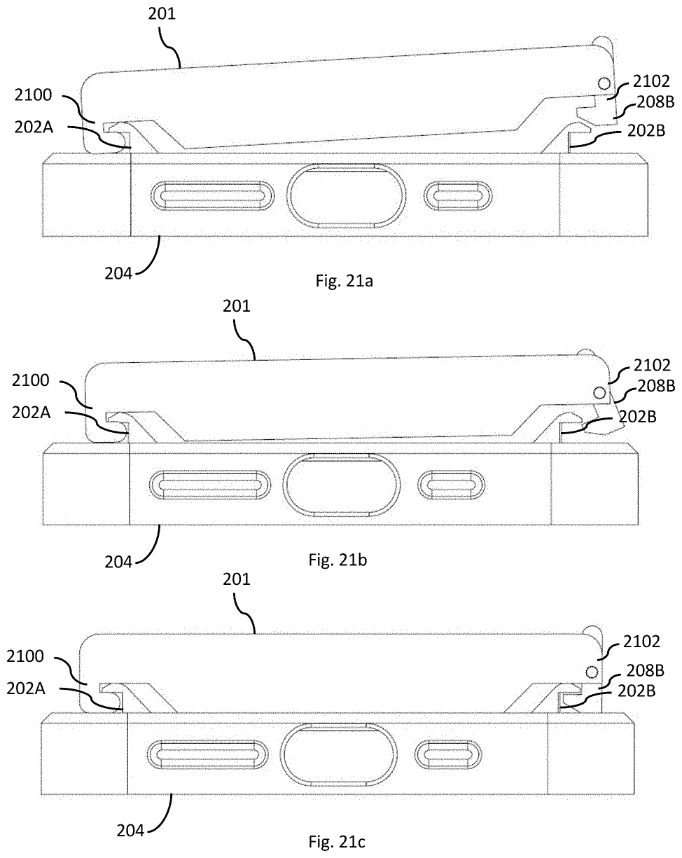

FIGS. 21a-21c are bottom views showing a sequence of using dual locking mechanisms 2100 and 2102 of an accessory 201 to engage and lock onto rails 202A and 202B, respectively, of an electronic device case 204 in accordance with embodiments of the present disclosure. Referring to FIG. 21a, locking mechanism 2102 operates the same as the locking mechanism 200B shown in FIGS. 20a-20c. In contrast, locking mechanism 2100 is static and does not have moving component like the arm 208B of the locking mechanism 2102. In this example, locking mechanism 2100 is positioned as shown to lock onto rail 202A as shown in FIG. 21a. Subsequently, locking mechanism 2102 is moved downward such that the arm 208B engages the rail 202B as shown in FIG. 21b. Lastly, the arm 208B locks onto rail 202B such that the accessory 201 is locked into place.

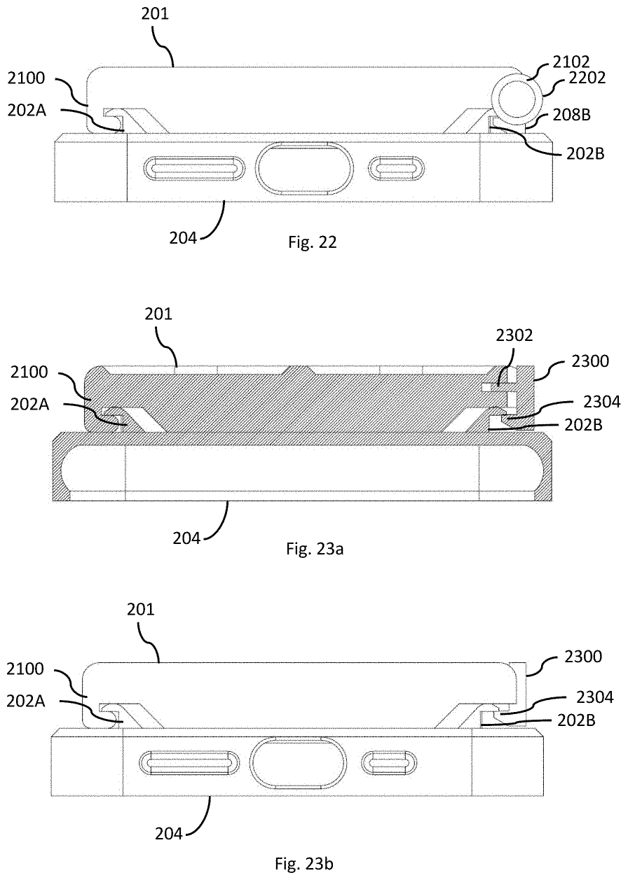

FIG. 22 illustrates a bottom view showing another example accessory 201 with dual locking mechanisms 2100 and 2102 similar to the accessory 201 shown in FIGS. 21a-21c. Alternative to the top portion of the arm being used for moving the arm as with the example of FIGS. 21a-21c, this example utilizes a knob 2200 that can be turned by an operator for moving the arm for release of the accessory 201.

FIGS. 23a and 23b are a cross-sectional bottom view and a bottom view, respectively, of an accessory 201 with a cam locking mechanism 2300 for locking to an electronic device case 204 in accordance with embodiments of the present disclosure. Referring to FIG. 23a, cam locking mechanism 2300 includes a cam 2302 and a protrusion 2304. The cam 2302 can be moved in a direction inward to hold onto the accessory 201. Also, when the cam 2302 moves inward, the protrusion 2304 engages and locks onto rail 202B. For release, the locking mechanism 2300 can be moved outward such that the protrusion 2304 releases from the rail 202B. The locking mechanism 2100 functions similar to the locking mechanism 2100 described for the example of FIGS. 21a-21c. In FIG. 23b, the cam 2302 is hidden from view.

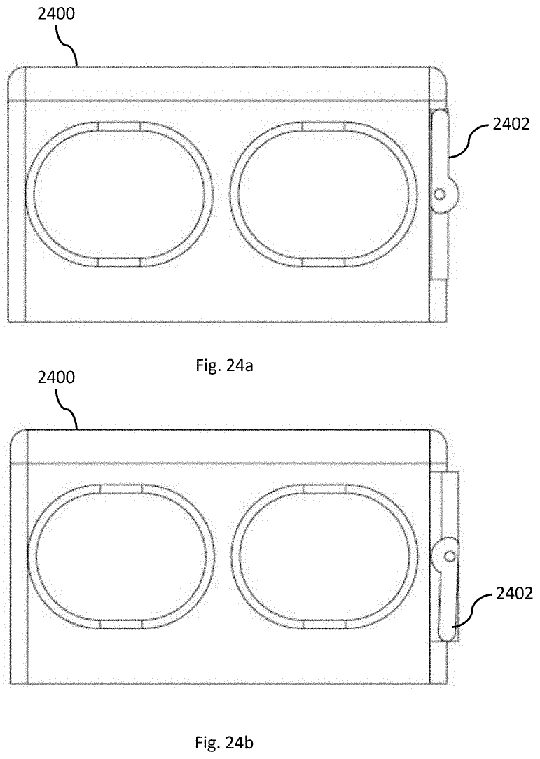

FIGS. 24a and 24b are a top views of an accessory 2400 with a locking mechanism with a lever 2402 for locking to an electronic device case in accordance with embodiments of the present disclosure. Referring to FIG. 24a, the lever 2402 is positioned in an upward position along the electronic device case for locking the accessory 2400 in a desired position. In order to unlock the accessory 2400 for movement of the accessory 2400 along a track of the case, the lever 2402 can be moved to the unlocked position as shown in FIG. 24b. This lever device can act as a cam to both pull and push the locking mechanism against the track, or it can be used just to unlock the accessory where a spring can pull it back to a locking position. Furthermore, when actuated, the cam can dig into or grip the track, thereby using friction or serrations to lock into place.

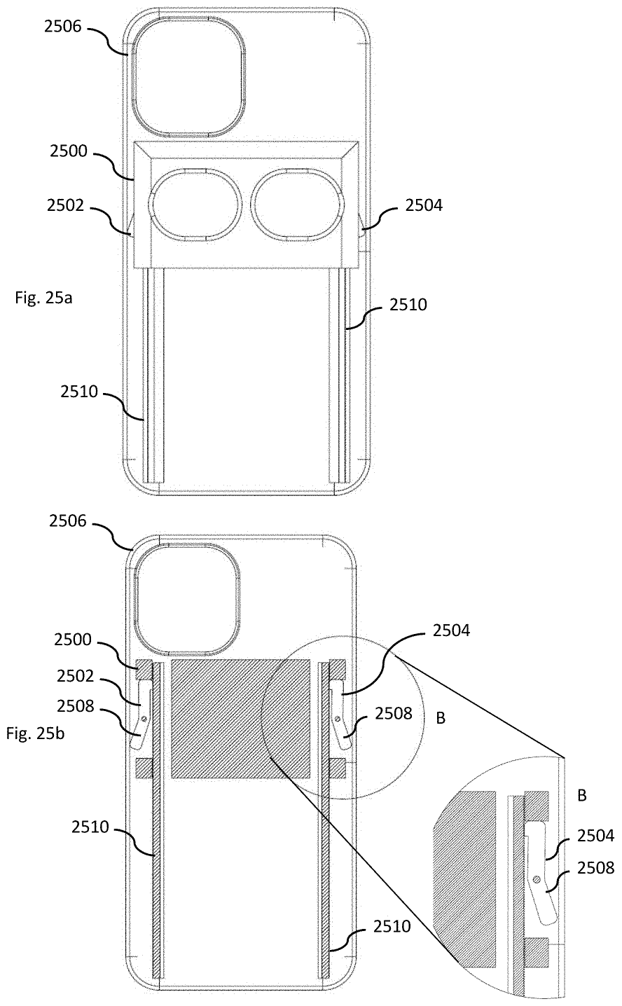

FIGS. 25a and 25b are a top view and a cross-sectional top view, respectively, of an accessory 2500 with dual-rotating locking mechanisms 2502 and 2504 for locking to an electronic device case 2506 in accordance with embodiments of the present disclosure. Referring to FIG. 25a, the accessory 2500 is shown locked in position at near an upper end of the case 2506. Now turning to FIG. 25b, the mechanism 2502 and 2504 each include a lever 2508 that can pivot for locking the accessory 2500 in position by engaging a feature along a respective rail 2510. An operator can push the levers 2508 to release the engagement with rails 2510. The mechanisms 2502 and 2504 may include biasing members for biasing the levers to a locked position. FIG. 25b includes a magnified portion B to show better detail of the locking mechanism 2504. The accessory may be pushed into position one way without actuation of the levers, where the levers need to be actuated to unlock the accessory. This can be used with one lever or both levers as shown.

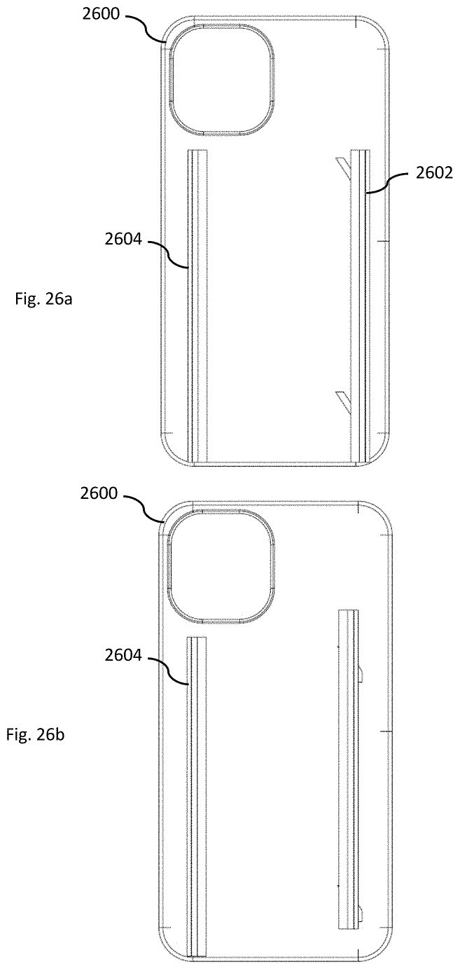

FIGS. 26a and 26b are top views of an electronic device case 2600 having a rail 2602 with a cam slide mechanism for locking an accessory (not shown) into place in accordance with embodiments of the present disclosure. The case 2600 also includes another rail 2604 that functions with rail 2602 for holding an accessory. Referring to FIG. 26a, the rail 2604 is in an outward position for locking to an accessory along with rail 2604. In order to unlock for releasing an accessory or receiving an accessory, an operator can either push or pull the rail 2602 from the top or bottom. By moving the rail 2602 upward, the rail 2602 moves to the position shown in FIG. 26b for release or receipt of an accessory. The rail 2604 can be moved back to the locked position by use of a biasing mechanism (e.g., use of a spring) or by the user pulling/pushing the rail 2604 to detent/snap location as shown in FIG. 26a. This can be utilized on the case or on the accessory.

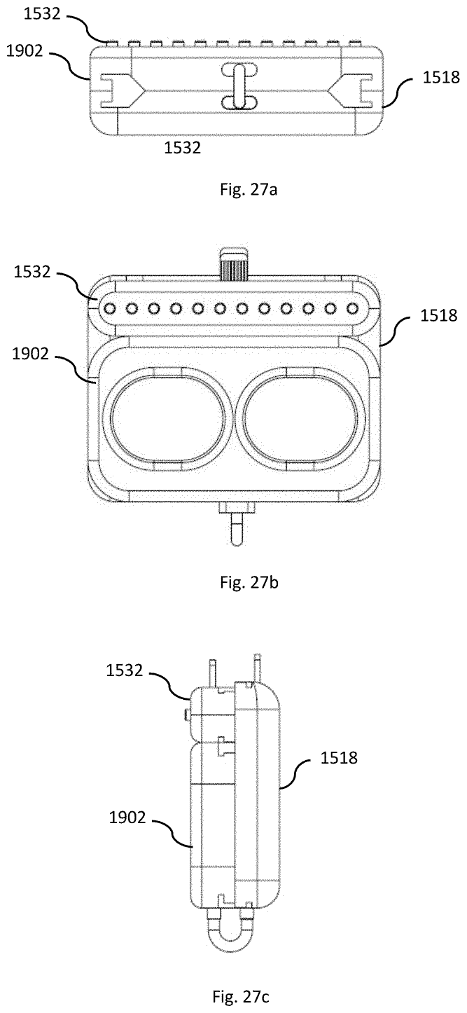

FIGS. 27a-27c are a bottom view, a top view, and a side view, respectively, of accessories 1518, 1532, and 1902 operatively connected together via their electrical interfaces in accordance with embodiments of the present disclosure. In this configuration, the accessories 1518, 1532, and 1902 can operate apart from an electronic device. The accessor 1518 is a battery that can power the other accessories: a light bar 1532 and a speaker 1902. The accessories can be removed and coupled back to back and used separately. They can be held together with a suitable mechanism, such as magnets. The battery 1518 can be connected to the phone via wireless communication (e.g., BLUETOOTH® wireless communication). The light bar 1532 and speaker 1902 can receive power from the battery 1518.

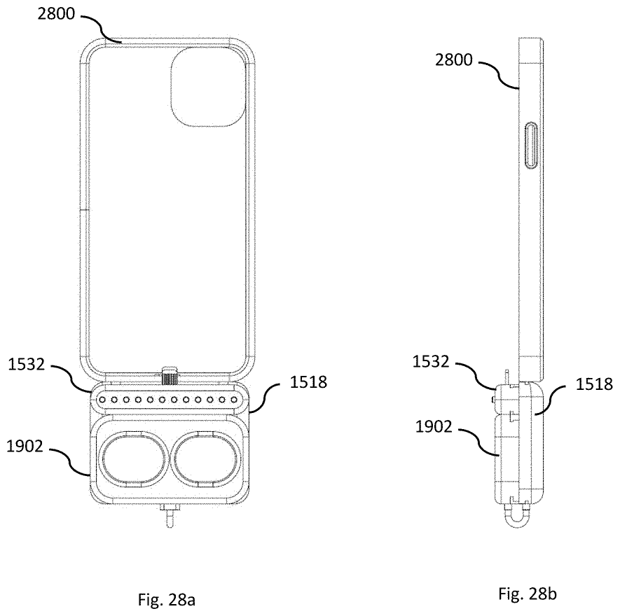

FIGS. 28a and 28b are a top view and a side view, respectively, showing the accessories 1518, 1532, and 1902 of FIGS. 27a-27c being connected directly to an electronic device within case 2800. Particularly, using an electrical plug on the battery 1518, it can be plugged into the electronic device as shown.

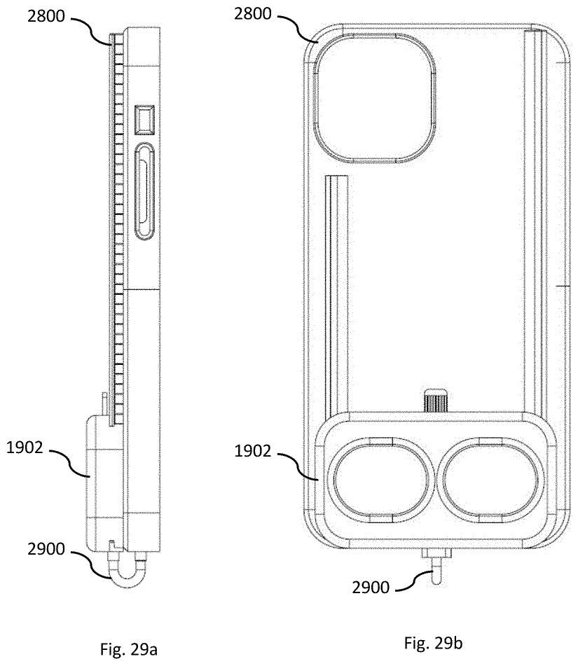

FIGS. 29a and 29b are a side view and a top view, respectively, showing operable connection of a speaker 1902 to an electronic device (not shown) within an electronic device case 2800 via cable 2900 in accordance with embodiments of the present disclosure. In this way, the electronic device can directly power the speaker 1902 or another accessory without a battery.

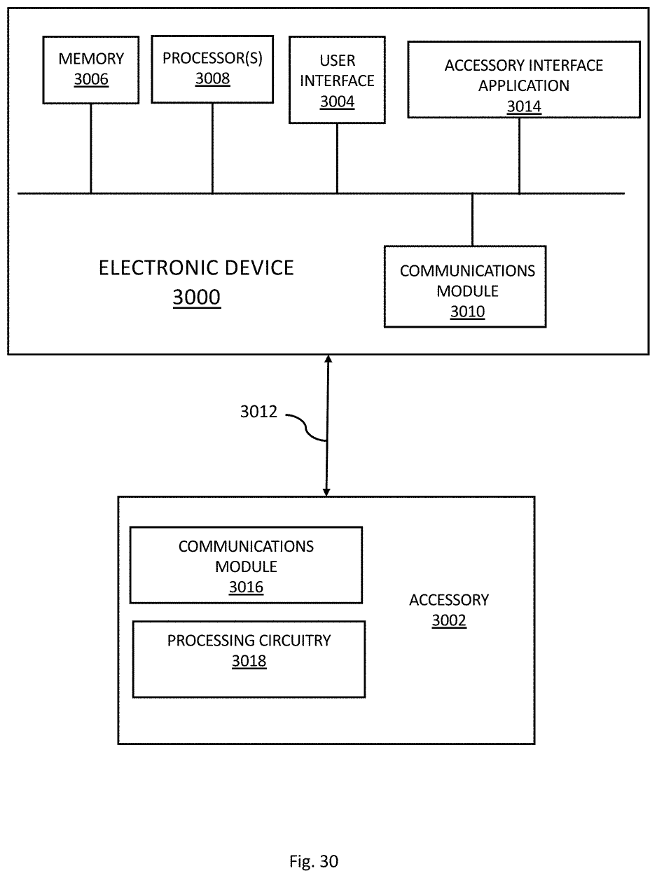

FIG. 30 illustrates a block diagram depicting an electronic device 3000 and an accessory 3002 that are operably connected in accordance with embodiments of the present disclosure. Referring to FIG. 30, the electronic device 3000 can include a user interface 3004 (e.g., touchscreen display, keyboard, one or more buttons, one or more speakers, and a microphone) for suitably interacting with its operator as will be understood by those of skill in the art. The electronic device 3000 can also include hardware, software, firmware, or combinations thereof for implementing functionality for user interaction, for implementing functions described herein, and for implementing applications and other processes as will be understood by those of skill in the art. For example, the electronic device 3000 can include memory 3006 and one or more processors 3008. The electronic device 3000 can also include a communications module 3010 for communicating with other electronic devices and accessories as described herein. For example, the communications module 3010 may be used for sending data to and for receiving data from the accessory 3004. For example, the communications module 3010 may suitably establish a communication connection 3012 with the accessory 3002. The communication connection 3012 may be a wired connection (e.g., via a cable) and/or a wireless connection (e.g., via BLUETOOTH® communication connection).

An accessory interface application 3014 may reside on the electronic device 3000 for interaction with the accessory 3004 and/or other accessories. The accessory interface application 3014 may be implemented by hardware, software, firmware, or combinations thereof of the electronic device 3000. In an example, the user interface 3004 may be utilized by the application 3014 to present data (e.g., text and/or graphics) indicating a status or other information about the accessory 3002. This status or other information may be received via the connection 3012, and the application 3004 may receive and control the user interface 3004 to present the information. Further, for example, a user may interact with the user interface 3004 for controlling the presentation of information and for controlling the accessory 3002. For example, the user may input a control instruction for controlling a volume of a speaker accessory, an intensity of light generated by a lighting accessory, or the like.

The accessory 3002 can include a communications module 3016 (e.g., antenna and other circuitry) for sending signals to and receiving signals from the electronic device 3000 via the connection 3012. Further, the accessory 3002 can include processing circuitry 3018 for implementing functionalities of the accessory (e.g., using the communications module 3016 to send/receive signals, controlling accessory function such as speaker volume control, light intensity for lighting, battery operations control, and the like). The processing circuitry 3018 can also interact with the application 3014 via the connection 3012 and the communications modules 3010 and 3016 for implementing functionalities as described herein for a user to interact with and receive information from an accessory.

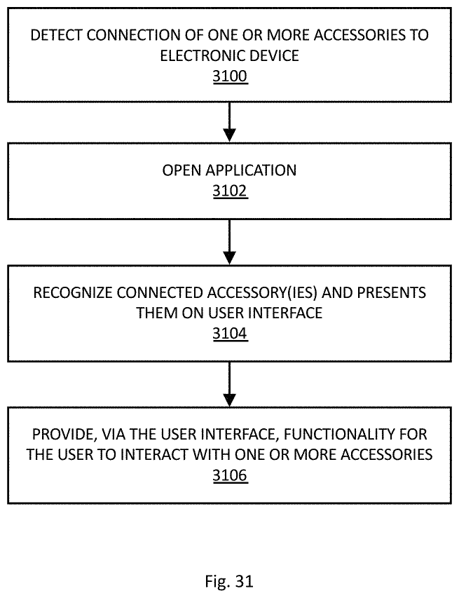

FIG. 31 illustrates a flow diagram depicting an example method of interaction between an electronic device and a connected accessory in accordance with embodiments of the present disclosure. The method is described as being implemented by the electronic device 3000 and the accessory 3002 shown in FIG. 30, but it should be understood that the method may be implemented by any other suitable electronic device and accessory.

Referring to FIG. 31, the method includes detecting 3100 connection of one or more accessories to an electronic device. For example, the accessory 3002 may be connected to (e.g., locked onto a case as described herein). In one particular example, a battery accessory and other accessory (e.g., speaker accessory or lighting accessory) can be connected to the electronic device 3000. The electronic device 3000 can recognize the connection. The connection can be a hard connection (e.g., via cable) and/or a wireless communication connection (e.g., via BLUETOOTH® communication).

The method of FIG. 31 includes opening 3102 an application on the electronic device. Continuing the aforementioned example, the user may open the accessory interface application 3014 or the application 3014 may be opened in response to recognition of the connection to the accessory 3002.

The method of FIG. 31 includes recognizing 3104 one or more connected accessories and presenting the accessory(ies) via a user interface. Continuing the aforementioned example, the application 3014 can recognize accessories and present information and/or a representation of them via a user interface 3004.

Any of the presented application can be selected by the user via the user interface 3004 to open various logic functionalities of the selected accessory. For example, the method of FIG. 31 includes providing 3106, via the user interface, functionality for the user to interact with one or more accessories. Continuing the aforementioned example, the user may interact with the user interface 3004 for controlling operations of an accessory. In the example of a lighting accessory (e.g., a light bar), the user may select to turn on/off a hot key, flash with a phone call, flash with text, select a lighting color, signal SOS, andor the like. In the example of a speaker accessory, the user may select to turn on/off a hot key, eefault use with phone speaker setting, ring through the speaker after a set number of rings (e.g., 5 rings), sound settings, base setting, treble setting, mid range setting, and/or the like. In the example of a battery accessory, the user may select to display battery life (e.g., on home screen), automatically engage on low power mode, save 20% of battery power for emergencies, engage a wireless communication mode (e.g., BLUETOOTH® mode), and/or the like. Once an accessory is disconnected, the application 3014 may no longer provide interactivity and indicate that the accessory is no longer available.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. An electronic device case comprising:
a body that defines an interior space for holding an electronic device;
a track attached to a side of the body and comprising first and second rails, wherein the rails each define a protrusion that extends substantially along a length of the track, and wherein the protrusion of the first rail and the protrusion of the second rail extend in substantially opposing directions; and
a locking mechanism comprising a resilient member that engages the first and second rails for biasing the first and second rails in a first position for holding an accessory, and wherein the resilient member resists movement of the first and second rails to a second position for release or receipt of the accessory.

2. The electronic device case of claim 1, wherein the electronic device is selected from the group consisting of a cellular phone, a smartphone, a tablet computer, a laptop computer, a handheld gaming device, a global position satellite (GPS) unit, a portable music player, a gaming console, an electronic reader, a camera, a digital camera, a smart watch, and a personal digital assistant.

3. The electronic device case of claim 1, wherein the protrusions are arcuate in shape.

4. The electronic device case of claim 1, wherein the protrusions each define a slot for engaging a corresponding protrusion of the accessory.

5. The electronic device case of claim 1, wherein another space is defined by and between the rails for positioning of at least a portion of the accessory when the accessory is held by the first and second rails.

6. The electronic device case of claim 1, wherein the resilient member comprises a spring.

7. An electronic device case comprising:
a body that defines an interior space for holding an electronic device;
a track attached to a side of the body and comprising first and second rails, wherein the rails each define a protrusion that extends substantially along a length of the track, and wherein the protrusion of the first rail and the protrusion of the second rail extend in substantially opposing directions; and
wherein the first and second rails are configured to engage a locking mechanism of an accessory, the accessory defining first and second portions that are configured to hold to the first and second rails, respectively, the accessory further comprising a resilient member that engages the first and second portions for biasing the first and second portions in a first position for holding to the first and second rails, respectively, and wherein the resilient member resists movement of the first and second portions to a second position for release of the accessory from the first and second rails or attachment of the first and second portions to the first and second rails, respectively.

8. The electronic device case of claim 7, wherein the protrusions are arcuate in shape.

9. The electronic device case of claim 7, wherein the protrusions each define a slot for engaging a corresponding protrusion of the accessory.

10. The electronic device case of claim 7, wherein the resilient member comprises a spring.

11. An electronic device case comprising:
a body that defines an interior space for holding an electronic device; and
a track attached to a side of the body and comprising first and second rails, wherein at least one of the rails defines a plurality of locking protrusions arranged along a length thereof, wherein the locking protrusions are each configured to engage a corresponding feature of an accessory for holding the accessory in one of a plurality of positions along the length of the track.

12. The electronic device case of claim 11, wherein the electronic device is selected from the group consisting of a cellular phone, a smartphone, a tablet computer, a laptop computer, a handheld gaming device, a global position satellite (GPS) unit, a portable music player, a gaming console, an electronic reader, a camera, a digital camera, a smart watch, and a personal digital assistant.

13. The electronic device case of claim 11, wherein the rails each define a protrusion that extends substantially along a length of the track, and wherein the protrusion of the first rail and the protrusion of the second rail extend in substantially opposing directions.

14. The electronic device case of claim 11, wherein the protrusions are arcuate in shape.

15. The electronic device case of claim 11, wherein the protrusions each define a slot for engaging a corresponding protrusion of the accessory.

16. The electronic device case of claim 11, wherein another space is defined by and between the rails for positioning of at least a portion of the accessory when the accessory is held by the first and second rails.

17. A system comprising:
an electronic device case comprising:
a body that defines an interior space for holding an electronic device;
a track attached to a side of the body and comprising first and second rails,
wherein the rails each define a protrusion that extends substantially along a length of the track, and wherein the protrusion of the first rail and the protrusion of the second rail extend in substantially opposing directions; and
an accessory comprising a locking mechanism defining at least one feature, wherein the locking mechanism comprises a resilient member that biases the at least one feature in a first position for grasping one of the rails, and wherein in a second position the accessory is releasable from the electronic device case.

18. The system of claim 17, wherein the protrusions are arcuate in shape.

19. The electronic device case of claim 17, wherein the protrusions each define a slot for engaging a corresponding protrusion of the accessory.

20. The electronic device case of claim 17, wherein another space is defined by and between the rails for positioning of at least a portion of the accessory when the accessory is held by the first and second rails.

21. A method comprising:
detecting connection of an accessory to an electronic device;
opening an application on the electronic device based on the connection of the accessory; and
providing, via user interface of the electronic device, user interactivity function for user interaction with the accessory.

22. The method of claim 21, wherein detecting connection comprises detecting one or wired or wireless connection between the accessory and the electronic device.

23. The method of claim 21, wherein the accessory is selected from the group consisting of a speakers, camera, battery, lighting, temperature sensing device, humidity sensing device, barometric pressure sensing device, microphone amplifier, motion sensor, extra storage, credit card reader, plug adaptor, breathalyzer, distance sensor, thermal camera, keypad, keyboard, joystick, other controllers, air quality sensor, gas sensor, GPS antenna, altimeter, machine learning camera, fingerprint sensor, radiation sensor, potentiometer, encoder, barcode scanner, muscle sensor, beam break sensor, projector, plug adaptors, blood sugar monitor, pulse oxygen reader, and earbud holders.

24. The method of claim 21, wherein the connection is via an electronic device case.

25. The method of claim 21, further comprising:
receiving, via the user interface, a user command for controlling the accessory; and
communicating the user command to the accessory.

26. The method of claim 21, further comprising:
receiving data from the accessory; and
presenting, via the user interface, a representation of the data.
